(19) United States
(12) Patent Application Publication
(10) Pub. No.: US 2020/0161032 A1
(43) Pub. Date: May 21, 2020

(54) RARE-EARTH SINTERED MAGNET AND RARE-EARTH SINTERED MAGNET SINTERED BODY FOR USE WITH SAME, AND MAGNETIC FIELD APPLYING DEVICE USABLE FOR MANUFACTURING SAME

(71) Applicant: NITTO DENKO CORPORATION, Ibaraki-shi, Osaka (JP)

(72) Inventors: Kenichi FUJIKAWA, Ibaraki-shi, Osaka (JP); Takashi YAMAMOTO, Ibaraki-shi, Osaka (JP); Shoichiro SAITO, Ibaraki-shi, Osaka (JP); Takashi OZAKI, Ibaraki-shi, Osaka (JP); Katsuya KUME, Ibaraki-shi, Osaka (JP)

(21) Appl. No.: 16/611,618

(22) PCT Filed: May 8, 2018
(86) PCT No.: PCT/JP2018/017794

§ 371 Date: Nov. 7, 2019

(30) Foreign Application Priority Data
May 8, 2017 (JP) 2017-092487

(51) Int. Cl. H01F 1/057; H01F 13/00; H01F 41/02; H01F 7/02; H01F 1/053

(52) U.S. Cl. CPC H01F 1/057; H01F 13/00; H01F 1/0536; H01F 7/02; H01F 41/02

(57) ABSTRACT

The rare-earth sintered magnet has a configuration in which a large number of magnet material particles including a rare-earth substance and each having an axis of easy magnetization have been integrally sintered. The rare-earth sintered magnet is provided with a first surface and a second surface opposing each other in the thickness direction. In a plane in parallel with a width direction and the thickness direction, the magnet material particles are magnetized such that, in a region extending from each of both end portions in the width direction toward the center portion in the width direction, the orientation direction of the easy magnetization axis is gradually changed. A maximum surface magnetic flux density in the first surface and a maximum surface magnetic flux density in the second surface satisfy the relationship (D1/D2)≥4.

### CROSS REFERENCE TO RELATED APPLICATION

This application claims the priority of Japanese Patent Application No. 2017-092487, filed on May 8, 2017 in the JPO (Japanese Patent Office). Further, this application is the National Phase Application of International Application No. PCT/JP2018/017794, filed on May 8, 2018, which designates the United States and was published in Japan. Both of the priority documents are hereby incorporated by reference in their entireties.

### TECHNICAL FIELD

The present invention relates to a rare-earth sintered magnet and a sintered body for the rare-earth sintered magnet for use with the same, and a magnetic field applying device usable for manufacturing the same.

### BACKGROUND ART

A linear motor is used in many devices such as industrial motors for manufacturing semiconductors and liquid crystals, shavers, and the like. For example, as described in JP 2004-297843A, a glass substrate is inspected using a stage on which an image processing device or the like is mounted in a manufacturing process for a liquid crystal display in some cases, and the linear motor capable of processing with high accuracy and at a high speed is used as driving means for this stage. This type of linear motor has a stator including a magnet unit including a plurality of permanent magnets disposed to face each other with a gap between them and a rotor including a three-phase coil in a magnetic gap, and is configured to obtain a driving force for driving the rotor to cause a driving current to flow though the three-phase coil.

In order to obtain a sufficient driving force in such a linear motor, it is necessary that the magnet has a sufficient magnetic force, in other words, that a surface magnetic flux density of a magnetic flux generated from the magnet is sufficiently large, but as a result, the magnet needs some degrees of a volume and a thickness. On the other hand, in order to drive the stage at a high speed, a size or a weight of the magnet unit needs to be reduced, and an increase in the volume or thickness of the magnet is not preferable. Moreover, a yoke for reducing a leakage magnetic flux by a magnetic circuit connecting one surfaces (principal surface) of the magnet in a thickness direction toward the rotor side and the other surface opposing to that is provided in the magnet unit in general, but there is a concern that the size or the weight of the magnet unit is increased by these yokes. Furthermore, in the aforementioned linear motor, for example, it is only necessary that the magnetic flux is generated in the one surface on which the rotor is disposed, and the magnetic flux generated on the other surface is basically unnecessary or rather can cause the leakage magnetic flux by the magnetic circuit, which is not preferable.

### CITATION LIST

### Patent Document

Patent Document 1: JP 2004-297843A

### SUMMARY OF INVENTION

### Technical Problem

The present invention has been made in view of solving the above conventional problem in such a prior art, and an object thereof is to provide a rare-earth sintered magnet which can generate a magnetic flux having practically useful surface magnetic flux density only in one surface in a thickness direction or mainly in one surface in a thickness direction without increasing a size or a weight of a magnet unit, and a sintered body for the rare-earth sintered magnet for use with the same. In addition, another object thereof is to provide a magnetic field applying device usable for manufacturing same.

### Solution to Technical Problem

In order to solve the aforementioned problem, a rare-earth sintered magnet according to an aspect of the present invention is a rare-earth sintered magnet having a configuration in which a number of magnet material particles including a rare-earth substance and each having an easy magnetization axis are integrally sintered, the rare-earth sintered magnet having a three-dimensional shape with a width direction, a thickness direction, and a length direction and including a first surface and a second surface opposing each other in the thickness direction, in which in a plane in parallel with the width direction and the thickness direction, the magnet material particles are oriented such that, in a region extending from each of both end portions in the width direction toward the center portion in the width direction, the orientation direction of the easy magnetization axis is gradually changed, and a maximum surface magnetic flux density in the first surface and a maximum surface magnetic flux density in the second surface satisfy the relationship (D1/D2)≥4.

According to the rare-earth sintered magnet in this aspect, since the magnetic flux having practically useful surface magnetic flux density can be generated only in the first surface (one surface) of the magnet in the thickness direction or mainly in the one surface in the thickness direction, there is no need to provide many magnet materials on the second surface (the other surface) and there is no need to provide a yoke for catching a leakage magnetic flux leaking out of the magnetic circuit, or only a small quantity of the yoke needs to be provided, and as a result, a small-sized and light-weighted rare-earth sintered magnet can be provided.

According to the rare-earth sintered magnet in the above aspect, the orientation directions of the easy magnetization axes may be different between each of both end portions in the width direction and a center portion in the width direction by 90°±5° or 180°±5°.

Moreover, in the rare-earth sintered magnet in the above aspect, the orientation directions of the easy magnetization axes may be different between each of the both end portions in the width direction and the center portion in the width direction by 90°±5°, and only an N-pole or an S-pole is generated in the first surface.

Moreover, in the rare-earth sintered magnet in the above aspect, the orientation directions of the easy magnetization axes may be different between each of the both end portions in the width direction and the center portion in the width direction by 180°±5°, and the N-pole or the S-pole is generated on the one side in the width direction of the first surface, while the S-pole or the N-pole with polarity opposite to that on the one side is generated on the other side in the width direction of the first surface.

In the rare-earth sintered magnet in the above aspect, the maximum surface magnetic flux density on the first surface is preferably 0.25T or more.

By setting the maximum surface magnetic flux density in the first surface large, a useful surface magnetic flux density for driving of the linear motor and the like can be also obtained.

Moreover, in the rare-earth sintered magnet in the above aspect, the maximum surface magnetic flux density on the second surface is preferably 0.15T or less.

By setting the maximum surface magnetic flux density on the second surface small, a leakage magnetic flux can be reduced.

In the rare-earth sintered magnet in the above aspect, the maximum surface magnetic flux density per unit thickness obtained by dividing the maximum surface magnetic flux density in the first surface by a thickness dimension in the thickness direction between the first surface and the second surface is preferably 0.06T/mm or more.

As a result, the maximum surface magnetic flux density can be improved efficiently.

In the rare-earth sintered magnet in the above aspect, axial symmetry obtained by obtaining surface magnetic flux density distribution in the width direction at a plurality of positions in the length direction and by comparing the surface magnetic flux density distributions obtained at the plurality of positions with each other is preferably 0.7 or less.

By creating excellent symmetry, control of the linear motor or the like can be made easy and thrust fluctuation can be suppressed.

In the rare-earth sintered magnet in the above aspect, the thickness dimension in the thickness direction is preferably 10 mm or less.

If the thickness dimension is too large, a sufficient magnetic field cannot be applied to the rare-earth sintered magnet sintered body depending on a currently available magnetic field applying device and thus, the thickness dimension in the thickness direction is preferably limited to a certain size in order to obtain a desired surface magnetic flux density by sufficiently magnetizing the sintered body.

In the rare-earth sintered magnet in the above aspect, the width dimension in the width direction on the plane is preferably 40 mm or less.

If the width dimension is too large, a sufficient magnetic field cannot be applied to the rare-earth sintered magnet sintered body depending on a currently available magnetic field applying device and thus, the width dimension in the width direction is preferably limited to a certain size in order to obtain the desired surface magnetic flux density by sufficiently magnetizing the sintered body.

The rare-earth sintered magnet in the above aspect may have a cuboid shape.

In order to solve the above problem, a rare-earth sintered magnet sintered body according to an aspect of the present invention is a rare-earth sintered magnet sintered body having a configuration in which a large number of magnet material particles including the rare-earth substance and each having the easy magnetization axis are integrally sintered, the rare-earth sintered magnet sintered body having a three-dimensional shape with a width direction, a thickness direction, and a length direction and including a first surface and a second surface opposing each other in the thickness direction, in which in the plane in parallel with the width direction and the thickness direction, the magnet material particles are oriented such that the orientation direction of the easy magnetization axis is gradually changed in a region from each of the both end portions in the width direction toward the center portion in the width direction, and the magnet material particles are oriented so that the maximum surface magnetic flux density of the magnet material particles each having the easy magnetization axis oriented in a direction crossing the first surface on the first surface and the maximum surface magnetic flux density of the magnet material particles each having the easy magnetization axis oriented in a direction crossing the second surface on the second surface satisfy a relationship of (D1′/D2′)≥4.

According to the rare-earth sintered magnet sintered body in this aspect, since the magnetic flux having practically useful surface magnetic flux density can be generated only in the first surface (one surface) of the magnet in the thickness direction or mainly in the one surface in the thickness direction, there is no need to provide many magnet materials on the second surface (the other surface) and there is no need to provide a yoke for catching a leakage magnetic flux leaking out of the magnetic circuit, or only a small quantity of the yoke needs to be provided, and as a result, a small-sized and light-weighted rare-earth sintered magnet sintered body can be provided.

In the rare-earth sintered magnet sintered body in the above aspect, the orientation directions of the easy magnetization axes may be different between each of the both end portions in the width direction and the center portion in the width direction by 90°±5° or 180°±5°.

Moreover, in the rare-earth sintered magnet sintered body in the above aspect, the orientation directions of the easy magnetization axes may be different between each of the both end portions in the width direction and the center portion in the width direction by 90°±5°, and only the N-pole or the S-pole is generated in the first surface.

Moreover, in the rare-earth sintered magnet sintered body in the above aspect, the orientation direction of the easy magnetization axis may be different between each of the both end portions in the width direction and the center portion in the width direction by 180°±5°, and the N-pole or the S-pole is generated on the one side in the width direction of the first surface, while the S-pole or the N-pole with polarity opposite to that on the one side is generated on the other side in the width direction of the first surface.

In the rare-earth sintered magnet sintered body in the above aspect, a thickness dimension in the thickness direction is preferably 10 mm or less.

If the thickness dimension is too large, a sufficient magnetic field cannot be applied to the rare-earth sintered magnet sintered body depending on a currently available magnetic field applying device and thus, the thickness dimension in the thickness direction is preferably limited to a certain size in order to obtain the desired magnetic flux density by sufficiently magnetizing the sintered body.

In the rare-earth sintered magnet sintered body in the above aspect, the width dimension in the width direction is preferably 40 mm or less.

If the width dimension is too large, a sufficient magnetic field cannot be applied to the rare-earth sintered magnet sintered body depending on a currently available magnetic field applying device and thus, the width dimension in the width direction is preferably limited to a certain size in order to obtain the desired surface magnetic flux density by sufficiently magnetizing the sintered body.

In order to solve the above problem, the magnetic field applying device according to an aspect of the present invention includes a magnetic body yoke including a pair of yoke legs located at an interval in the width direction and a recess portion formed between the pair of yoke legs, and on a side adjacent to the recess portion on each of upper surfaces of the pair of yoke legs, a work placing portion across the recess portion of the magnetic body yoke is formed between the pair of yoke legs so that a work placing surface with a predetermined width is formed, and a magnetic field is applied to a work placed on the work placing portion, forming a magnetic field from one of the pair of yoke legs via a portion corresponding to the work placing surface on the upper surface of one of the yoke legs, passing through the work placed on the work placing portion in the width direction, via a portion corresponding to the work placing surface on the upper surface of the other of the pair of yoke legs and reaching the other yoke leg.

In the magnetic field applying device in the above aspect, a pair of non-magnetic body yokes disposed on the upper surfaces of the pair of yoke legs are further provided, each of the pair of non-magnetic body yokes is positioned on each of the upper surfaces of the pair of yoke legs with respect to the corresponding yoke legs so that the work placing surface with the predetermined width is left on a side adjacent to the recess portion of the magnetic body yoke, a work placing portion across the recess portion of the magnetic body yoke is formed between the pair of non-magnetic body yokes, and the magnetic field may be formed with respect to the work placed on the work placing portion, from one of the pair of yoke legs via a portion corresponding to the work placing surface on the upper surface of the one of yoke legs, passing through the work placed on the work placing portion in the width direction, via a portion corresponding to the work placing surface on the upper surface of the other of the pair of yoke legs and reaching the other yoke leg.

In the magnetic field applying device in the above aspect, the pair of yoke legs have a portion extending with the recess portion in a length direction orthogonal to both the width direction and the thickness direction of the recess portion, and the formed magnetic field is preferably formed by using a first conductor disposed on the recess portion along the length direction, a second conductor disposed along the length direction on a side opposite to the recess portion with respect to one of the pair of yoke legs in the width direction, and a third conductor disposed along the length direction on the side opposite to the recess portion with respect to the other of the pair of yoke legs in the width direction.

Moreover, in the magnetic field applying device in the above aspect, a direction of a current made to flow through the first conductor and a direction of the current made to flow through the second and third conductors are opposite to each other.

Furthermore, in the magnetic field applying device in the above aspect, the first conductor is made of a pair of conductors separated in the width direction, and it is preferable that one of the conductors in the pair of conductors disposed on a side closer to one of the pair of yoke legs in the width direction is connected to the second conductor, and the other conductor in the pair of conductors disposed on the side closer to the other of the pair of yoke legs in the width direction is connected to the third conductor.

In the magnetic field applying device in the above aspect, the magnetic body yoke further includes a plurality of additional yoke legs located at intervals from each other in the width direction between the pair of yoke legs and a recess portion formed between the pair of yoke legs and the plurality of additional yoke legs and between the plurality of additional yoke legs and between the plurality of additional yoke legs, and a first magnetic field toward the upper surface of one yoke leg in the pair of yoke legs adjacent to one yoke leg in the plurality of additional yoke legs and/or toward the upper surface of any of the other yoke legs in the plurality of additional yoke legs adjacent to the one yoke leg from the upper surface of the one yoke leg passing through the work placed on the work placing portion in the width direction and a second magnetic field from the upper surface of one yoke leg of the pair of yoke legs adjacent to the one yoke leg in the plurality of additional yoke legs and/or from the upper surface of any of the other yoke legs in the plurality of additional yoke legs adjacent to the one yoke leg toward the upper surface of the one yoke leg passing through the work placed on the work placing portion in the width direction may be formed alternately in the width direction between the pair of yoke legs and the plurality of additional yoke legs adjacent to each other.

Moreover, in the magnetic field applying device in the above aspect, the pair of yoke legs and the plurality of additional yoke legs have a portion extending with the recess portion in the length direction orthogonal to both the width direction and the thickness direction of the recess portion, and the first magnetic field and the second magnetic field may be formed by using a plurality of conductors disposed so as to sandwich each of the plurality of additional yoke legs in the width direction and disposed on the recess portion along the length direction.

Furthermore, in the magnetic field applying device in the above aspect, a direction of the current made to flow through the conductor disposed on the one side in the width direction and a direction of the current made to flow through the conductor disposed on the other side in the width direction are directions opposite to each other for each of the plurality of additional yoke legs.

Furthermore, in the magnetic field applying device in the above aspect, the conductor disposed on the one side in the width direction and the conductor disposed on the other side in the width direction are preferably connected to each other for each of the plurality of additional yoke legs.

### Effect of Invention

According to the present invention, the rare-earth sintered magnet which can generate the magnetic flux having practically useful surface magnetic flux density only in the one surface in the thickness direction or mainly in the one surface in the thickness direction without increasing the size or the weight of the magnet unit, and the sintered body for the rare-earth sintered magnet for use with the same can be provided. Moreover, the magnetic field applying device which can be used for manufacturing them can be provided.

### BRIEF DESCRIPTION OF DRAWINGS

FIGS. 1A and 1B are a perspective diagram depicting a unipolar anisotropic rare-earth sintered magnet according to an embodiment of the present invention.

FIGS. 2A and 2B are a perspective diagram depicting a bipolar anisotropic rare-earth sintered magnet according to an embodiment of the present invention.

FIG. 3 is a perspective diagram depicting a tripolar anisotropic rare-earth sintered magnet according to an aspect of an embodiment of the present invention.

FIG. 4 is a perspective diagram depicting a tripolar anisotropic rare-earth sintered magnet according to another aspect of an embodiment of the present invention.

FIG. 5 is a diagram depicting an example of surface magnetic flux density distribution obtained by the unipolar anisotropic rare-earth sintered magnet depicted in FIGS. 1A and 1B.

FIG. 6 is a diagram depicting a use example of the rare-earth sintered magnet depicted in FIGS. 1A and 1B.

FIG. 7 is a diagram depicting an example of surface magnetic flux density distribution obtained by the bipolar anisotropic rare-earth sintered magnet depicted in FIGS. 2A and 2B.

FIG. 8 is a diagram depicting a use example of the rare-earth sintered magnet depicted in FIGS. 2A and 2B.

FIG. 9 is a diagram depicting an example of surface magnetic flux density distribution obtained by the tripolar anisotropic rare-earth sintered magnet according to the aspect depicted in FIG. 3.

FIG. 10 is a diagram depicting an example of surface magnetic flux density distribution obtained by the tripolar anisotropic rare-earth sintered magnet according to the another aspect depicted in FIG. 4.

FIG. 11 is a schematic diagram illustrating an orientation angle and an orientation axis angle.

FIG. 12 is a graph illustrating a process of determining an orientation angle deviation.

FIGS. 13A, 13B and 13C depicts a distribution of orientation angles based on an EBSD analysis, wherein: FIG. 13A is a perspective view depicting directions of coordinate axes taken in a rare-earth sintered magnet; FIG. 13B depicts examples of pole figures obtained in a central region and opposite end regions of the magnet by the EBSD analysis; and FIG. 13C depicts orientation axis angles in a cross-section of the magnet taken along an A2 axis in FIG. 13A:

FIGS. 14A, 14B, 14C and 14D is a diagram depicting part of a process of producing a rare-earth magnet-forming material.

FIG. 15 is a graph presenting a desired temperature rise rate in calcination treatment.

FIG. 16 is a schematic chart of a heat treatment to be performed in a sintering step.

FIG. 17 is a perspective view on an end portion of a magnetic field applying device which can be used for manufacturing the bipolar anisotropic rare-earth sintered magnet depicted in FIGS. 2A and 2B.

FIG. 18 is a sectional view of the magnetic field applying device depicted in FIG. 17.

FIG. 19 is a diagram depicting an example of an electric circuit usable for generating a pulse magnetic field.

FIG. 20 is a diagram depicting a use example of the magnetic field applying device depicted in FIG. 17.

FIG. 21 is a sectional view of the magnetic field applying device which can be used for manufacturing the tripolar anisotropic rare-earth sintered magnet depicted in FIG. 4.

FIG. 22 is a diagram depicting a use example of the magnetic field applying device depicted in FIG. 21.

FIG. 23 is a sectional view of the magnetic field applying device which can be used for manufacturing the unipolar anisotropic rare-earth sintered magnet depicted in FIGS. 1A and 1B.

FIG. 24 is a diagram depicting the surface magnetic flux density distribution used for acquiring axial symmetry.

FIG. 25 is a diagram depicting measurement spots where the surface magnetic flux density for acquiring the axial symmetry.

### DESCRIPTION OF EMBODIMENTS

With reference to the accompanying drawings, the present invention will be described based on a preferred embodiment thereof. Although only a preferred embodiment of the present invention will be described below for the same of simplicity, it is to be understood that such an embodiment is not intended to limit the present invention.

### 1. RARE-EARTH SINTERED MAGNET

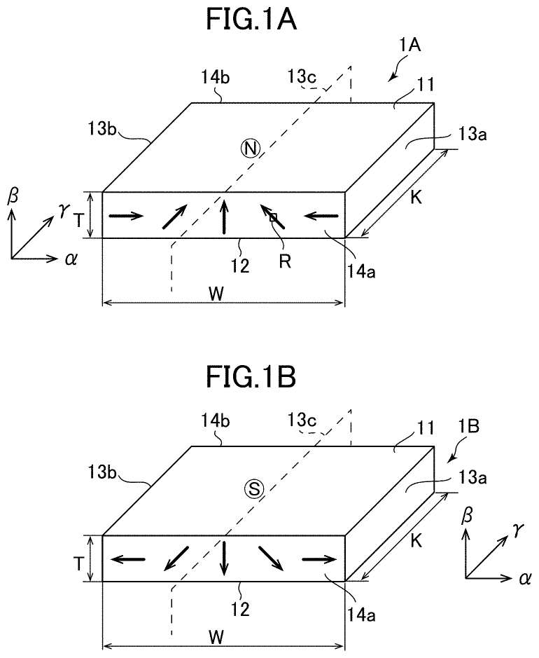

FIGS. 1A, 1B, 2A, 2B, 3 and 4 depict various configuration aspects of rare-earth sintered magnets 1 to 4 by an embodiment of the present invention in conceptual diagrams.

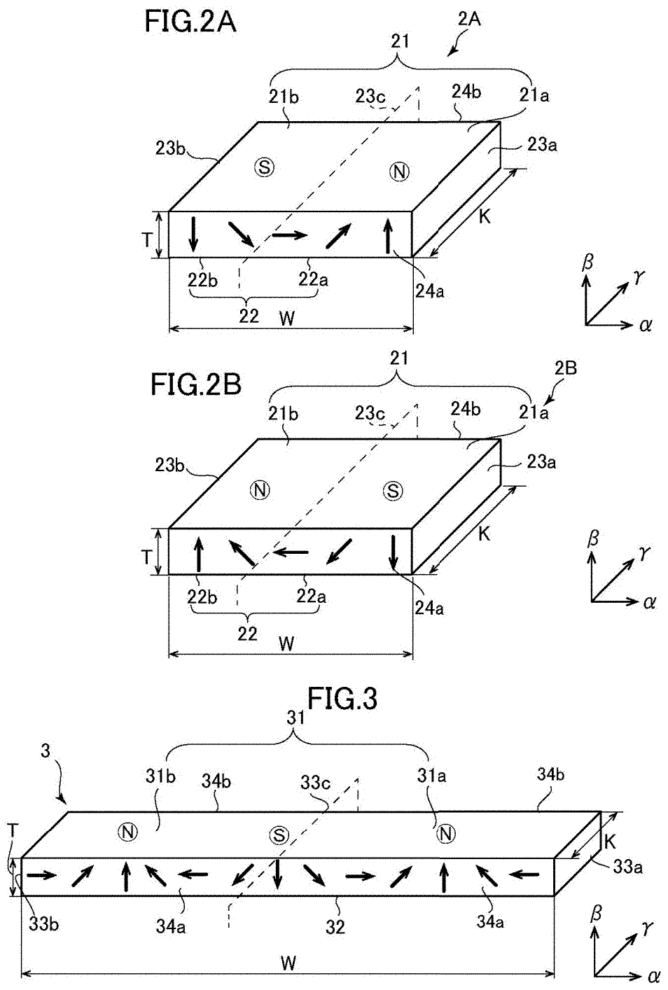

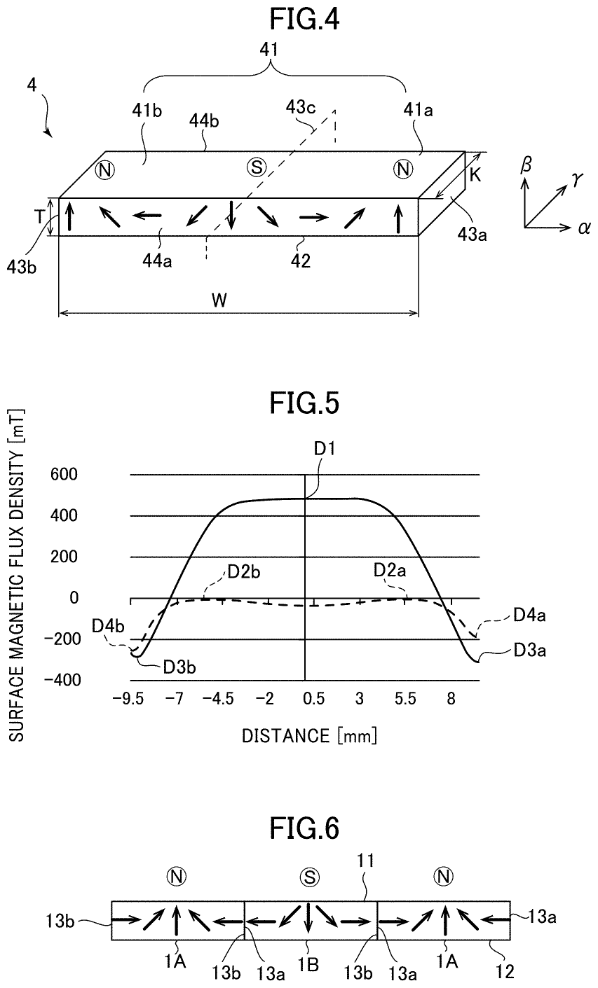

In these rare-earth sintered magnets, a plurality of arrows depicted in a flat end surface in parallel with a width direction “α” and a thickness direction “β”, that is, in each of an end surface 14a of the rare-earth sintered magnet 1 in FIGS. 1A and 1B, an end surface 24a of the rare-earth sintered magnet 2 in FIGS. 2A and 2B, an end surface 34a of the rare-earth sintered magnet 3 in FIG. 3, and an end surface 44a of the rare-earth sintered magnet 4 in FIG. 4 schematically depicts a direction of an orientation axis of an easy magnetization axis (orientation direction of the easy magnetization axis) of magnet material particles constituting these rare-earth sintered magnets. This direction can correspond to a magnetization direction of the magnet material particles or in other words, to a direction which is the same or substantially corresponds to a direction of magnetization of the rare-earth sintered magnet. Though not particularly depicted, it may be considered that the orientation axis in the same direction is formed on an end surface on an opposite side, that is, the end surfaces 14b and the like.

FIGS. 1A and 1B are a perspective view depicting a unipolar anisotropic rare-earth sintered magnet 1 or in more detail, the rare-earth sintered magnet 1 which can generate a magnetic flux having practically useful surface magnetic flux density only in one surface 11 in the thickness direction “β” or mainly in one surface in the thickness direction and has substantially only one polarity of either of an N-pole and an S-pole on the one surface 11.

FIG. 1A particularly depicts a rare-earth sintered magnet 1A generating substantially only the N-pole on the one surface 11, and FIG. 1B particularly depicts a rare-earth sintered magnet 1B generating substantially only the S-pole on the one surface 11, respectively. A substantial difference between the rare-earth sintered magnet 1A and the rare-earth sintered magnet 1B is only a point that the polarities exerted on the surface 11 are opposite, and other points can be considered to be substantially the same.

FIGS. 2A and 2B are a perspective view depicting a bipolar anisotropic rare-earth sintered magnet or in more detail, the rare-earth sintered magnet 2 which can generate a magnetic flux having practically useful surface magnetic flux density only in one surface 21 in the thickness direction “β” or mainly in one surface in the thickness direction and has substantially the polarities of the N-pole and the S-pole one each on the one surface 21.

FIG. 2A particularly depicts a rare-earth sintered magnet 2A generating the N-pole on one side 21a and the S-pole on the other side 21b when seen from a perpendicular surface 23c located at a center portion in the width direction “α” on the one surface 21, and FIG. 2B particularly depicts a rare-earth sintered magnet 2B generating the S-pole on one side 21a and the N-pole on the other side 21b when seen from a perpendicular surface 23c located at a center portion in the width direction “α” on the one surface 21, respectively. A substantial difference between the rare-earth sintered magnet 2A and the rare-earth sintered magnet 2B is only a point that the polarities exerted on the surface 21 are opposite, and other points can be considered to be substantially the same.

FIGS. 3 and 4 are perspective views depicting tripolar anisotropic rare-earth sintered magnets 3 and 4 or in more detail, the rare-earth sintered magnets 3 and 4 which can generate the magnetic flux having practically useful surface magnetic flux density only in one surfaces 31 and 41 in the thickness direction “β” or mainly in one surface in the thickness direction and have substantially “N-pole, S-pole, N-pole” or “S-pole, N-pole, S-pole” in these orders on the one surfaces 31 and 41.

The rare-earth sintered magnet 3 in FIG. 3 generates the S-pole at the center portion in the width direction “α” and the N-pole on one side 31a and the other side 31b, respectively, when seen from a perpendicular surface 33c located at the center portion on the one surface 31. On the other hand, the rare-earth sintered magnet 4 in FIG. 4 generates the N-pole at the center portion in the width direction “α” and the S-pole on one side 41a and the other side 41b, respectively, when seen from a perpendicular surface 43c located at the center portion on the one surface 41. Though not particularly depicted, as depicted in FIGS. 1A and 1B and FIGS. 2A and 2B, a magnet having the polarities exerted in the surfaces 31 and 41 in the opposite direction can be realized by reversing the direction of magnetization.

Moreover, the rare-earth sintered magnet 3 depicted in FIG. 3 can be regarded as the one connecting the rare-earth sintered magnet 1A and the rare-earth sintered magnet 1B depicted in FIGS. 1A and 1B to each other on their side surfaces or in more detail, the one having substantially the same configuration as a structure depicted in FIG. 3. Similarly, the rare-earth sintered magnet 4 depicted in FIG. 4 can be regarded as the one connecting the rare-earth sintered magnet 2A and the rare-earth sintered magnet 2B depicted in FIGS. 2A and 2B to each other on their side surfaces or in more detail, the one having substantially the same configuration as a part of a structure depicted in FIG. 6. Thus, according to the rare-earth sintered magnets 3 and 4 in FIGS. 3 and 4, a magnet having a shape in which the rare-earth sintered magnet 1 and the rare-earth sintered magnet 2 are connected can be obtained without any extra work.

Any of the rare-earth magnets 1 to 4 depicted in FIGS. 1A, 1B, 2A, 2B, 3 and 4 includes a three-dimensional shape having a width direction (an arrow “α” direction in FIGS.), a thickness direction (an arrow “β” direction in FIGS.), and a length direction (an arrow “γ” direction in FIGS.) orthogonal to each other. As depicted in FIGS. 1A, 1B, 2A, 2B, 3 and 4, they may have cuboid shape, for example. However, the shape does not necessarily have to be cuboid and only needs to include a three-dimensional shape in which the width direction, the thickness direction, and the length direction can be specified. Thus, a surface in the width direction and in the thickness direction may be an arc shape or a trapezoidal shape, for example. Terms such as the width direction, the thickness direction, and the length direction are only for convenience in specifying the orientation direction of the easy magnetization axis and the surface (principal surface) which can generate the magnetic flux having practically useful surface magnetic flux density and the surface opposing that and do not specify a relation of lengths among them, for example.

A width dimension “W” in the width direction “α” of the rare-earth sintered magnets 1 to 4 is preferably small within a practical range, and when performances of a currently available magnetic field applying device are considered, it needs to be 10 mm or more and 40 mm or less, 30 mm or less is preferable, 20 mm or less is more preferable, and 10 mm or less is further preferable. If the width dimension “W” is too small or too large, since a sufficient magnetic field cannot be applied to the rare-earth sintered magnet sintered body depending on the currently available magnetic field applying device, the width dimension in the width direction is preferably limited to a certain size in order to obtain the desired surface magnetic flux density by sufficiently magnetizing the sintered body.

A thickness dimension “t” in the thickness direction “β” is preferably small within a practical range. By decreasing the thickness dimension, the size or the weight of the magnet unit can be reduced. However, if the thickness dimension is too small, sufficient surface magnetic flux density cannot be generated and thus, it needs to be at least 1 mm or more. On the other hand, if the thickness dimension is too large, since a sufficient magnetic field cannot be applied to the rare-earth sintered magnet sintered body, it needs to be 12 mm or less in order to sufficiently magnetize the sintered body by considering the performances of the currently available magnetic field applying device, 10 mm or less is preferable, 8 mm or less is more preferable, 6 mm or less is further preferable, and 4 mm or less is furthermore preferable. Moreover, as will be described later, if the thickness dimension is too large, since the maximum surface magnetic flux density cannot be improved efficiently, the thickness dimension in the thickness direction is preferably limited to a certain size while the maximum surface magnetic flux density is kept at a desired value also from a viewpoint that the maximum surface magnetic flux density is improved efficiently.

A length dimension “K” in the length direction “γ” can be determined relatively freely, but it is preferably 5 mm to 100 mm, more preferably 5 mm to 50 mm or further preferably 5 mm to 40 mm by considering the performances of the currently available magnetic field applying device.

### <Unipolar Anisotropic Rare-Earth Sintered Magnet>

FIG. 5 depicts an example of the surface magnetic flux density distribution obtained by the unipolar anisotropic rare-earth sintered magnet 1 depicted in FIGS. 1A and 1B. A horizontal axis indicates a distance (mm) from the perpendicular surface 13c located at the center portion in the width direction “α” of the rare-earth sintered magnet 1, and a vertical axis indicates a surface magnetic flux density (mT) at this position, respectively. In the figure, a solid line indicates the surface magnetic flux density distribution measured at a position separated from the one surface 11 in a direction opposite to the other surface 12 only by a predetermined distance in the thickness direction “β” or only by 1 mm, for example, while a broken line indicates the surface magnetic flux density distribution measured at a position separated from the other surface 12 in the direction opposite to the one surface 11 only by a predetermined distance in the thickness direction “β” or only by 1 mm, for example.

Here, the surface magnetic flux density distribution is set so as to be substantially symmetrical by adjusting the orientation direction of the easy magnetization axis or the like.

As is obvious from FIG. 4, the rare-earth sintered magnet 1A depicted in FIG. 1A generates the magnetic flux having a maximum surface magnetic flux density (hereinafter, referred to as the maximum surface magnetic flux density) D1 of a predetermined polarity or the N-pole, here, at the center portion (13c) in the width direction “α” and generates the magnetic flux having relatively large surface magnetic flux densities D3a and D3b of the opposite polarity or the S-pole, here, in the vicinity of side surfaces 13a and 13b located on both end portions in the width direction “α” on the one surface 11, for example. On the other hand, on the other surface 12, it generates the magnetic flux of the S-pole having small maximum surface magnetic flux densities D2a and D2b at positions biased to the side surfaces 13a and 13b rather than the center portion (13c) in the width direction “α” and generates the magnetic flux of the S-pole having relatively large surface magnetic flux densities 4Da and D4b at positions further biased to the side surfaces 13a and 13b.

As is obvious from above, the rare-earth sintered magnet 1 generates the magnetic flux having the practically useful surface magnetic flux density particularly in the vicinity of the center portion (13c) in the width direction “α”, here, only in the one surface 11 in the thickness direction “β” or mainly in the one surface in the thickness direction.

As depicted in FIG. 6, the plurality of rare-earth sintered magnets 1A and 1B can be alternately arrayed with their side surfaces 13a and 13b abutting to each other by using the magnetic force generated in the side surfaces 13a and 13b substantially without repulsion of the magnetic force. As a result, magnet orientation in which the N-pole and the S-pole are alternately arrayed on the one surface 11 can be easily configured.

### <Bipolar Anisotropic Rare-Earth Sintered Magnet>

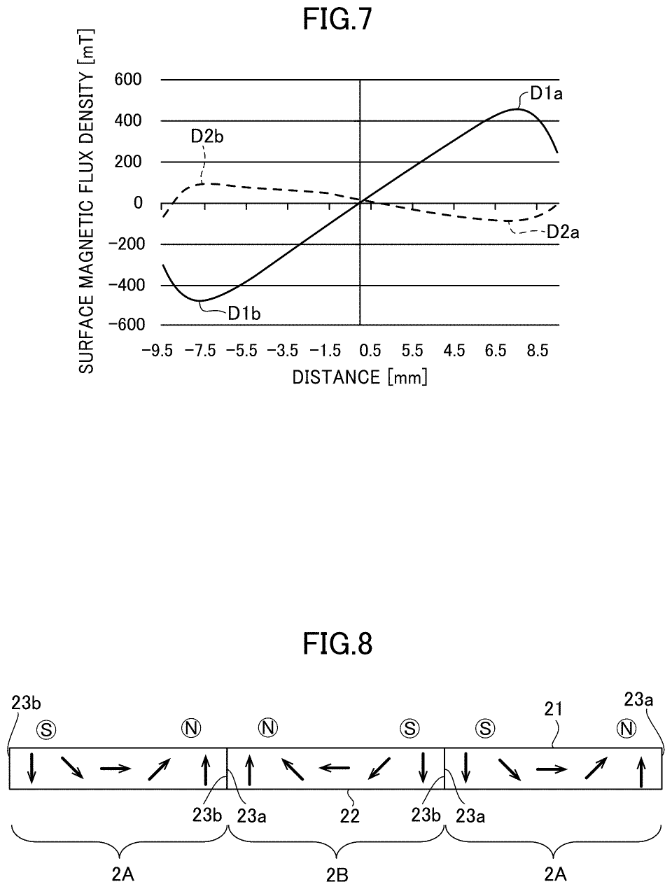

FIG. 7 depicts an example of the surface magnetic flux density distribution obtained by the bipolar anisotropic rare-earth sintered magnet 2 depicted in FIGS. 2A and 2B. Here, measurement of the surface magnetic flux density was conducted by a method similar to that in FIG. 5. The surface magnetic flux density distribution is set so as to have a substantially symmetric shape, here, by adjusting the orientation direction of the easy magnetization axis or the like.

In the rare-earth sintered magnet 2A depicted in FIG. 2A, for example, the surface magnetic flux density is substantially 0 at the center portion (23c) in the width direction “α” on the one surface 21 thereof, and on the one side 21a of the one surface 21, a magnetic flux having the maximum surface magnetic flux D1a of a predetermined polarity or the N-pole, here, is generated at a position biased to the one side surface 23a in the width direction “α”, and on the other side 21b of the one surface 21, a magnetic flux having the maximum surface magnetic flux density D1b of a polarity opposite to the one side 21a, that is, of the S-pole is generated at a position biased to the other side surface 23b in the width direction “α”. On the other hand, on the other surface 22, magnetic fluxes having maximum surface magnetic flux densities D2a and D2b of the polarity opposite to the one surface 21 are generated at a position similar to the one surface 21 in the width direction “α”, but these maximum surface magnetic flux densities D2a and D2b are extremely smaller than the maximum surface magnetic flux densities D1a and D1b and do not generate a leakage magnetic flux which causes a problem.

As is obvious from the above, the rare-earth sintered magnet 2 generates the magnetic flux having the practically useful surface magnetic flux density particularly at a position biased to the one side surface 23a or to the other side surface 23b rather than the center portion (23c) in the width direction “α”, here, only in the one surface 21 in the thickness direction “β” or mainly in the one surface in the thickness direction.

The magnetic forces generated in the side surfaces 23a and 23b located on the both end portions in the width direction “α” generate some or less repulsion to each other, but since the force is weak, a plurality of the rare-earth sintered magnets 2A and 2B can be also arrayed alternately in a state where their side surfaces 23a and 23b abut to each other as depicted in FIG. 8. As a result, the magnet array in which the N-pole and the S-pole are alternately arrayed on the one surface 21 can be configured.

### <Tripolar Anisotropic Rare-Earth Sintered Magnet>

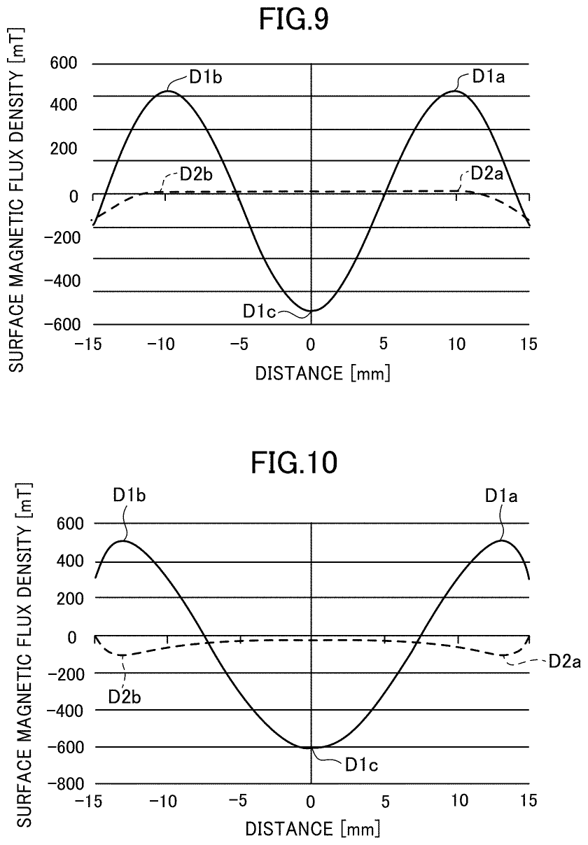

FIGS. 9 and 10 depict an example of the surface magnetic flux density distribution obtained by the tripolar anisotropic rare-earth sintered magnets 3 and 4 depicted in FIGS. 3 and 4, respectively. The measurement of the surface magnetic flux density, here, was conducted by the method similar to that in FIG. 5. The surface magnetic flux density distribution is set so as to have a substantially symmetric shape, here, by adjusting the orientation direction of the easy magnetization axis or the like.

As is obvious from FIG. 9, in the rare-earth sintered magnet 3 depicted in FIG. 3, for example, the magnetic flux having the maximum surface magnetic flux density D1c of a predetermined polarity or the S-pole, here, is generated at the center portion (33c) in the width direction “α” on the one surface 31 thereof, and on the one side 31a of the one surface 31, the magnetic flux having the maximum surface magnetic flux D1a of a predetermined polarity, that is, of the N-pole, here, is generated at a position biased to the one side surface 33a in the width direction “α”, and on the other side 31b of the one surface 31, the magnetic flux having the maximum surface magnetic flux density D1b of the same polarity as that of the one side 31a, that is, of the N-pole is generated at a position biased to the other side surface 33b in the width direction “α”. On the other hand, on the other surface 32, magnetic fluxes having maximum surface magnetic flux densities D2a and D2b of the same polarity as that of the one surface generating the magnetic flux having the value of substantially 0, here, are generated at a position similar to the one surface 31 in the width direction “α”, but these maximum surface magnetic flux densities D2a and D2b are extremely smaller than the maximum surface magnetic flux densities D1a and D1b and do not generate a leakage magnetic flux which causes a problem.

On the other hand, as is obvious from FIG. 10, in the rare-earth sintered magnet 4 in FIG. 4, on the one surface 41, for example, the magnetic flux similar to that of the rare-earth sintered magnet 3 depicted in FIG. 3 is generated, while on the other surface 42, the magnetic flux having the maximum surface magnetic flux densities D2a and D2b of the polarity opposite to that of the one surface 41 is generated at a position similar to the one surface 41 in the width direction “α”.

As is obvious from the above, the rare-earth sintered magnets 3 and 4 generate the magnetic flux having the practically useful surface magnetic flux density only in the one surfaces 31 and 41 in the thickness direction “β” or mainly in the one surface in the thickness direction or particularly at the center portions (33c, 43c) in the width direction “α” and positions biased to the one surfaces 33a and 43a or to the other side surfaces 33b and 43b rather than the center portions (33c, 43c) in the width direction “α”, here.

The rare-earth sintered magnets 3 and 4 depicted in FIGS. 3 and 4 can be also alternately arrayed in the state where the side surfaces 33a and 33b thereof or the side surfaces 43a and 43b abut to each other by the method similar to those depicted in FIGS. 6 and 8. As a result, the magnet array in which the N-pole and the S-pole are alternately arrayed on the one surfaces 31 and 41 can be configured.

As described above, since any of the rare-earth sintered magnets 1 to 4 depicted in FIGS. 1A, 1B, 2A, 2B, 3, 4 and 5 generates the magnetic flux having the practically useful surface magnetic flux density only in the one surface in the thickness direction “β” or mainly in the one surface in the thickness direction, there is no need to provide many magnet materials on the other surface, and there is no need to provide a yoke for catching the leakage magnetic flux leaking out of the magnetic circuit or it is only necessary to provide a small quantity of the yokes, and as a result, these rare-earth sintered magnets 1 to 4 are small-sized and light-weighted.

### 2. RARE-EARTH SINTERED MAGNET SINTERED BODY

The rare-earth sintered magnets 1 to 4 depicted in FIGS. 1A, 1B, 2A, 2B, 3 and 4 are obtained by magnetizing a sintered body for the rare-earth sintered magnets 1 to 4 (hereinafter, referred to as a “rare-earth sintered magnet sintered body”). Magnetization processing does not substantially change the shape and the dimension of the rare-earth sintered magnet sintered body. Therefore, the rare-earth sintered magnet sintered body can be considered to include a three-dimensional shape having the width direction (the arrow “α” direction in FIGS.), the thickness direction (the arrow “β” direction in FIGS.), and the length direction (the arrow “γ” direction in FIGS.) similarly to the rare-earth sintered magnets 1 to 4 and to have a shape corresponding to the rare-earth sintered magnets 1 to 4 or a cuboid shape as depicted in FIGS. 1A, 1B, 2A, 2B, 3 and 4, for example. Moreover, the size of the rare-earth sintered magnet sintered body can be considered to be substantially the same as the rare-earth sintered magnets 1 to 4, but since the rare-earth sintered magnet sintered body is somewhat polished for shaping in manufacturing the rare-earth sintered magnets 1 to 4, the size can be different in some cases.

A rare-earth magnet-forming material serving as a basis for the rare-earth sintered magnet sintered body includes a magnet material containing a rare-earth substance. As the magnet material, it is possible to use, e.g., an Nd—Fe—B based magnet material. In this case, for example, the Nd—Fe—B based magnet material may contain, in terms of weight percent: R (R denotes one or more rare-earth elements including Y) in an amount of 27.0 to 40.0 wt %, preferably, 27.0 to 35 wt %; B in an amount of 0.6 to 2 wt %, preferably, 0.6 to 1.1 wt %; and Fe which is electrolytic iron in an amount of 60 to 75 wt %. Typically, the Nd—Fe—B based magnet material contains: Nd in an amount of 27 to 40 wt %; B in an amount of 0.8 to 2 wt % of B; and Fe in an amount of 60 to 70 wt %. With a view to improving magnetic properties, this magnet material may contain other element such as Dy, Tb, Co, Cu, Al, Si, Ga, Nb, V, Pr, Mo, Zr, Ta, Ti, W, Ag, Bi, Zn, or Mg, in a small amount.

The magnet material is comprised in the rare-earth magnet-forming material, in the form of fine magnet material particles. The rare-earth sintered magnets 1 to 4 and the rare-earth sintered magnet sintered body have a configuration in which these magnet material particles are integrally sintered, that is, a form in which the magnet material particles are connected to each other with a connection structure specific to the magnet and the sintered body at any position in these magnets or sintered bodies and thus, they have the configuration different from a magnet or a magnet forming sintered body obtained by cutting out a piece with a desired shape from a magnet or a sintered body and bonding a plurality of cut-out pieces to each other, for example.

Each of the magnet material particles has an easy magnetization axis oriented in a predetermined direction as depicted by arrows in FIGS. 1A, 1B, 2A, 2B, 3 and 4. These easy magnetization axes are in a state oriented in the predetermined directions substantially depicted by the arrows in each of planes formed by the “α direction” and the “β direction” in each of FIGS. 1A, 1B, 2A, 2B, 3 and 4, for example in the planes of flat front end surfaces 14a, 24a, 34a, and 44a and rear end surfaces 14b, 24b, 34b, and 44b. More specifically, these easy magnetization axes are oriented in the directions depicted by the arrows in each of cross-sections in a “α-β direction” orthogonal to the length direction “γ”.

For example, an orientation direction of the easy magnetization axis in the rare-earth sintered magnet sintered body before the rare-earth sintered magnet 1 in FIGS. 1A and 1B are magnetized, or in more detail, a direction of magnetization in the rare-earth sintered magnet 1 in FIGS. 1A and 1B generated by magnetization after that in a direction substantially along such an orientation direction is different between each of the both end portions (13a, 13b) in the width direction “α” and the center portion (13c) in the width direction “α” by 90°±5°, and though not obvious from the figure, it is gradually changed in a region from each of the both end portions (13a, 13b) in the width direction “α” toward the center portion (13c) in the width direction “α”. Here, “±5°” is set by considering that some error can occur depending on a situation of the measurement or an applying method of a magnetic field, but the error of such a degree does not give a significant influence on the measurement of the surface magnetic flux density (the same applies to the following).

Similarly, the orientation direction of the easy magnetization axis in the rare-earth sintered magnet sintered body before the rare-earth sintered magnet 2 in FIG. 2 is magnetized, for example, or in more detail, a direction of magnetization in the rare-earth sintered magnet 2 in FIGS. 2A and 2B generated by magnetization after that in a direction substantially along such an orientation direction is different between each of the both end portions (23a, 23b) in the width direction “α” and the center portion (23c) in the width direction “α” by 90°±5°, and though not obvious from the figure, it is gradually changed in a region from each of the both end portions (23a, 23b) in the width direction “α” toward the center portion (23c) in the width direction “α”.

Moreover, the orientation direction of the easy magnetization axis in the rare-earth sintered magnet sintered body before the rare-earth sintered magnet 3 in FIG. 3 is magnetized, for example, or in more detail, a direction of magnetization in the rare-earth sintered magnet 3 in FIG. 3 generated by magnetization after that in a direction substantially along such an orientation direction is different between each of the both end portions (33a, 33b) in the width direction “α” and the center portion (33c) in the width direction “α” by 90°±5°, and though not obvious from the figure, it is gradually changed in a region from each of the both end portions (33a, 33b) in the width direction “α” toward the center portion (33c) in the width direction.

Furthermore, the orientation direction of the easy magnetization axis in the rare-earth sintered magnet sintered body before magnetizing the rare-earth sintered magnet 4 in FIG. 4, for example, or in more detail, a direction of magnetization in the rare-earth sintered magnet 4 in FIG. 4 generated by magnetization after that in a direction substantially along such an orientation direction is different between each of the both end portions (43a, 43b) in the width direction “α” and the center portion (43c) in the width direction “α” by 180°±5°, and though not obvious from the figure, it is gradually changed in a region from each of the both end portions (43a, 43b) in the width direction “α” toward the center portion (43c) in the width direction “α”.

The easy magnetization axis usually does not have polarity, but since it becomes a vector having a polarity when the magnet material particles are magnetized, arrows giving directionality to the easy magnetization axes are depicted in FIGS. 1A, 1B, 2A, 2B, 3 and 4 by considering magnetization-expected polarities. That is, in this Description, the term of the “orientation direction of the easy magnetization axis” or similar terms are used as expressing the direction by considering the magnetization-expected polarities as above.

Respective meanings of terms relating to orientation will be described below.

### [Orientation Angle]

The term “orientation angle” means an angle of the direction of the orientation axis of the easy magnetization axis of the magnet material particle with respect to a predetermined reference line.

### [Orientation Axis Angle]

The term “orientation axis angle” means a most frequently appearing orientation angle among orientation angles of the magnet material particles contained in a predetermined discrete area in a specific plane of a magnet. The area for determining the orientation axis angle is set as a rectangular area including at least 30, e.g., 200 to 300 magnet material particles, or a square area having a side length of 35 μm.

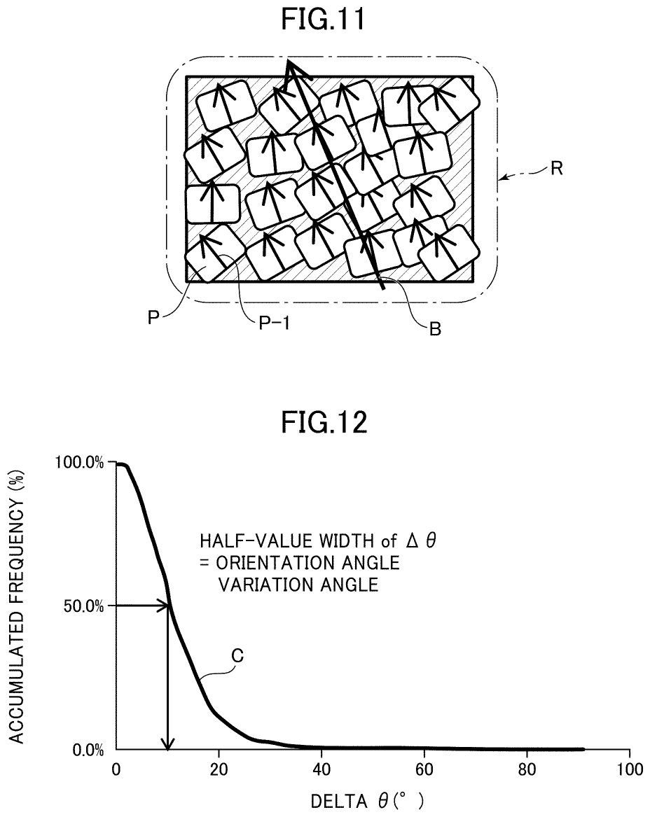

The “orientation axis angle” is an angle between these orientation axes denoted by arrows in FIGS. 1A, 1B, 2A, 2B, 3 and 4 and a single reference line. The reference line may be arbitrarily set, but in the case where each of cross-sections of the one surfaces 11, 21, 31, and 41 and the other surfaces 12, 22, 32, and 42 or the side surfaces 13, 23, 33, and 43 is denoted by a straight line as in examples depicted in FIGS. 1A, 1B, 2A, 2B, 3 and 4, for example, the lines constituting the cross-sections of these surfaces are conveniently used as the reference lines. FIG. 11 is a schematic enlarged view illustrating a process of determining the “orientation angles” and the “orientation axis angle” of the easy magnetization axes of the sintered magnet material particles. As an example, an arbitrary area of the rare-earth sintered magnet 1A depicted in FIG. 1A or a rectangular area R depicted in FIG. 1A, for example, is enlargedly depicted here. This rectangular area R includes a large number of, e.g., 30 or more, or 200 to 300, sintered magnet material particles P. As the number of the sintered magnet material particles included in the rectangular area becomes larger, measurement accuracy becomes better. However, even in a case where the number is only about 30, measurement can be performed with a sufficient accuracy. Each of the sintered magnet material particles P has the easy magnetization axis P-1.

As depicted in FIG. 11, the easy magnetization axis P-1 in each of the sintered magnet material particles P has an “orientation angle” which is an angle between a direction in which the easy magnetization axis P-1 is oriented, and the reference line. The orientation angle with the highest frequency in the “orientation angles” of the easy magnetization axes P-1 of the magnet material particles P in the rectangular area R depicted in FIG. 11 is defined as an “orientation axis angle” B, and a direction determined by this “orientation axis angle” is defined as an “orientation direction of the easy magnetization axis”. This direction also substantially corresponds to the magnetization direction of the magnet material particles and the “magnetization direction” and the “orientation direction of the easy magnetization axis” in the rare-earth sintered magnets 1 to 4.

### [Orientation Angle Deviation]

In an arbitrary rectangular area, a difference between the orientation axis angle and each of the orientation angles of the easy magnetization axes of all the sintered magnet material particles contained in the rectangular area is determined. Then, an angle value represented by a half width in a distribution of a deviation of the orientation angle with respect to the orientation axis angle is defined as an orientation angle deviation. FIG. 12 is a graph illustrating a process of determining the orientation angle deviation. In FIG. 12, a distribution of a deviation Δθ of the orientation angle of the easy magnetization axis in each of the sintered magnet material particles with respect to the easy magnetization axis is represented by a curve C. On the assumption that a position where a cumulative frequency represented in the vertical axis is maximized is defined as 100%, a value of the orientation angle deviation Δθ corresponding to a cumulative frequency of 50% is the half width.

### [Measurement of Orientation Angle]

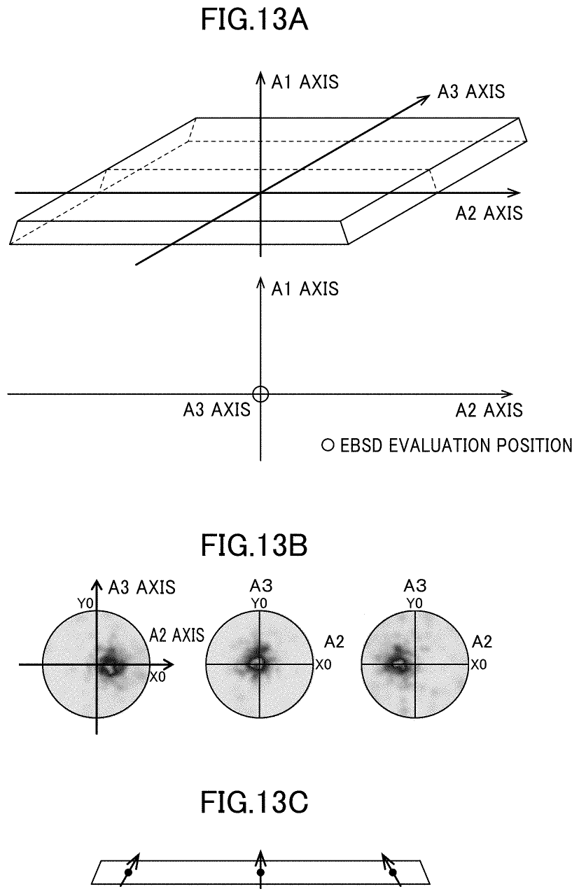

The orientation angle of the easy magnetization axis in each of the sintered magnet material particles P can be determined by an “Electron Back scatter Diffraction Analysis” (EBSD Analysis) based on a scanning electron microscopical (SEM) image. Examples of devices which can be used for the analysis are: JSM-70001F manufactured by Nihon Electron KK (JEOL Ltd.) having a head office in Akishima City, Tokyo, Japan, which is a scanning electron microscope equipped with an EBSD Detector (AZtecHKL EBSD NordlysNano Integrated) manufactured by Oxford Instruments, and SUPRA40VP manufactured by ZEISS, which is a scanning electron microscope equipped with an EBSD detector (Hikari High Speed EBSD Detector) manufactured by EDAX Inc. Further, examples of an entity who undertakes EBSD analysis as an outsourcing business include JFE Techno-Research Co., having a head office in Nihonbashi, Chuo-ku, Tokyo, Japan, and Nitto Analytical Techno-Center in Ibaraki City, Osaka, Japan. Through the EBSD analysis, it is possible to determine the orientation angles and the orientation axis angle regarding the easy magnetization axes of the sintered magnet material particles contained in a given area. FIG. 13 depicts one example of indication of orientation of the easy magnetization axis by the EBSD analysis, wherein FIG. 13A is a perspective view depicting directions of coordinate axes taken in a rare-earth sintered magnet, and FIG. 13B depicts examples of pole figures obtained at a central region and opposite end regions of the magnet by the EBSD analysis. Further, FIG. 13C depicts the orientation axis angles in a cross-section of the magnet taken along the A2 axis. The orientation axis angle can be indicated by dividing the orientation vector of the easy magnetization axis of the sintered magnet material particle into a first component in a plane including A1 and A2 axes, and a second component in a plane including A1 and A3 axes. The A2 axis is a width-directional axis, and the A1 axis is a thickness-directional axis. The figure at the center of FIG. 13B shows that, in the width-directional central region of the magnet, the orientation of the easy magnetization axis is approximately coincident with a direction along the A1 axis. On the other hand, the figure on the left side of FIG. 13B shows that, in the width-directional left end region of the magnet, the orientation of the easy magnetization axis extends obliquely upwardly and rightwardly from below the magnet, along a plane defined by the A1 and A2 axes. Similarly, the figure on the right side of FIG. 13B shows that, in the width-directional right end region of the magnet, the orientation of the easy magnetization axis extends obliquely upwardly and leftwardly from below the magnet, along the plane defined by the A1 and A2 axes. These orientations are depicted as orientation vectors in FIG. 13C. Here, the pole figures depicted in FIG. 13B was obtained by SUPRA40VP manufactured by ZEISS, which is a scanning electron microscope equipped with an EBSD detector (Hikari High Speed EBSD Detector) manufactured by EDAX Inc.

### 3. PRODUCTION METHOD FOR RARE-EARTH SINTERED MAGNET

A manufacturing method according to an embodiment of the present invention which can be used for manufacturing the rare-earth sintered magnets 1 to 4 depicted in FIGS. 1A, 1B, 2A, 2B, 3 and 4 will be described.

### (1) Production of Rare-Earth Magnet-Forming Material

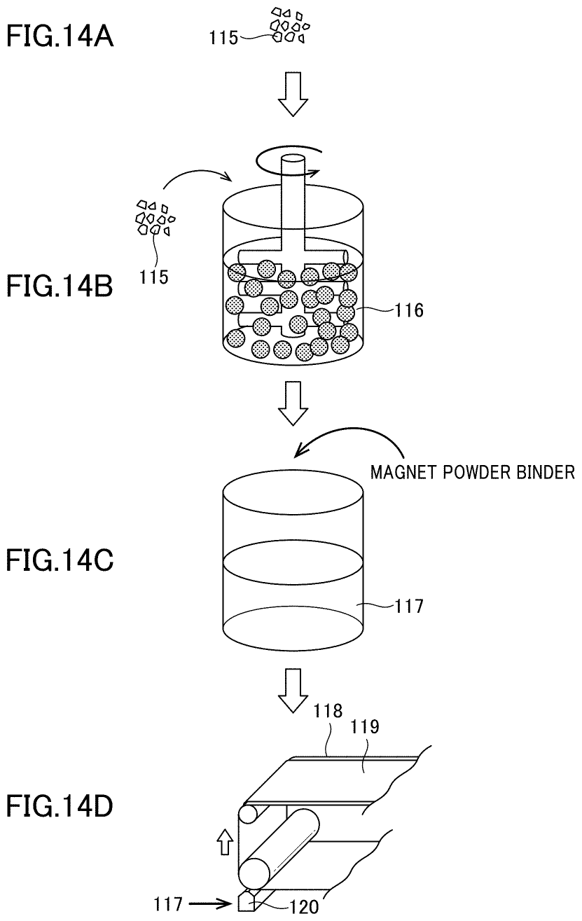

The rare-earth magnet-forming material serving as a basis for the rare-earth sintered magnets 1 to 4 is prepared. FIGS. 14A, 14B, 14C and 14D depicts part of a process of producing the rare-earth magnet-forming material. First of all, an ingot of a magnet material comprised of an Nd—Fe—B based alloy having a given mixing ratio is produced by a casting process. Typically, the Nd—Fe—B based alloy usable for a neodymium magnet has a composition comprising 30 wt % of Nd, 67 wt % of Fe which is preferably electrolytic iron, and 1.0 wt % of B. Subsequently, this ingot is coarsely pulverized to have a particle size of about 200 μm, using heretofore-known means such as a stamp mill or a crusher. Alternatively, the ingot may be melted and subjected to a strip casting process to produce flakes, and then the flakes may be coarsely powdered by a hydrogen cracking process. In this way, coarsely-pulverized magnet material particles 115 are obtained (see FIG. 14A).

Subsequently, the coarsely-pulverized magnet material particles 115 are finely pulverized by a pulverization method such as a wet process using a bead mill 116, or a dry process using a jet mill. For example, in the fine pulverization based on the wet process using the bead mill 116, the coarsely-pulverized magnet material particles 115 are finely pulverized, in the solvent, to an average particle size falling within a given range, e.g., 0.1 μm to 5.0 μm to thereby disperse the resulting magnet material particles in the solvent (see FIG. 14B). Subsequently, the magnet material particles contained in the solvent after the wet pulverization are dried by drying mean such as reduced-pressure drying, and the dried magnet material particles are taken out (not depicted). Here, a type of solvent usable in the pulverization is not particularly limited. For example, it is possible to use organic solvent such as: alcohols such as isopropyl alcohol, ethanol and methanol; esters such as ethyl acetate; lower hydrocarbons such as pentane and hexane; aromatics such as benzene, toluene and xylene; and ketones; and mixtures thereof. It is also possible to use an inorganic solvent such as liquefied nitrogen, liquefied helium, or liquefied argon. In any case, it is preferable to use a solvent containing no oxygen atom therein.

On the other hand, in the fine pulverization based on the dry process using the jet mill, the coarsely-pulverized magnet material particles 115 are finely pulverized by the jet mill, in (a) an atmosphere consisting inert gas such as nitrogen gas, Ar gas or He gas, wherein an oxygen content of the inert gas is 0.5% or less, preferably substantially 0%, or (b) an atmosphere consisting inert gas such as nitrogen gas, Ar gas or He gas, wherein an oxygen content of the inert gas is in the range of 0.001 to 0.5%, and pulverized into fine particles having an average particle size of 6.0 μm or less, or an average particle size falling within a given range, e.g., of 0.7 μm to 5.0 μm. Here, the term “the concentration of oxygen is substantially 0%” does not limitedly mean that the concentration of oxygen is absolutely 0%, but means that oxygen may be contained in an amount to an extent that it very slightly forms an oxide layer on surfaces of the fine particles. If hydrogen remains in the magnetic powder, an organic component is altered and thus, hydrogen is preferably removed from the pulverized magnetic powder. In order to remove hydrogen, the temperature may be raised from a room temperature to 120° C. or above in 0.5 hours, for example, and then, the temperature may be held for a predetermined period of time or one hour or more, for example.

Subsequently, the magnet material particles finely pulverized by the bead mill 116 or other pulverizing means are formed into a desired shape. For shaping of the magnet material particles, a mixture obtained by mixing the magnet material particles 115 finely pulverized in the above manner and a binder together, i.e., a composite material, is preliminarily prepared. As a resin material to be used as the binder, it is preferable to use a polymer containing no oxygen atom in its structure and having a depolymerization property. Further, it is preferable to use, as the resin material, a thermoplastic resin so as to enable a residue of the composite material of the magnet material particles and the binder, generated when the composite material is formed into a desired shape, to be reused, and enable magnetic field orientation to be performed under the condition that the resin material is softened by heating the composite material. More specifically, a polymer is suitably used which comprises one or more polymers or copolymers formed from a monomer represented by the following general formula (1):

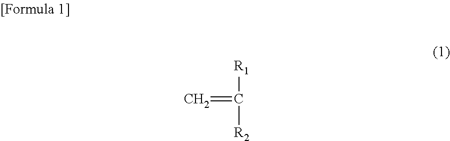

(where each of R1 and R2 denotes one of a hydrogen atom, a lower alkyl group, a phenyl group and a vinyl group.)

Examples of a polymer satisfying the above conditions include: polyisobutylene (PIB) as a polymer of isobutylene; polyisoprene (isoprene rubber (IR)) as a polymer of isoprene; polypropylene, a poly(α-methylstyrene) polymerized resin as a polymer of α-methylstyrene; polyethylene; polybutadiene (butadiene rubber (BR)) as a polymer of 1,3-butadiene; polystyrene as a polymer of styrene; a styrene-isoprene-styrene block copolymer (SIS) as a copolymer of styrene and isoprene; butyl rubber (IIR) as a copolymer of isobutylene and isoprene; a styrene-butadiene-styrene block copolymer (SBS) as a copolymer of styrene and butadiene; a styrene-ethylene-butadiene-styrene copolymer (SEBS) as a copolymer of styrene, ethylene and butadiene; a styrene-ethylene-propylene-styrene copolymer (SEPS) as a copolymer of styrene, ethylene and propylene; an ethylene-propylene copolymer (EPM) as a copolymer of ethylene and propylene; EPDM obtained by copolymerizing diene monomers together with ethylene and propylene; a 2-methyl-1-pentene polymerized resin as a polymer of 2-methyl-1-pentene; and a 2-methyl-1-butene polymerized resin as a polymer of 2-methyl-1-butene. A resin to be used as the binder may have a composition containing a polymer or copolymer of monomers containing an oxygen atom and/or a nitrogen atom (e.g., poly(butyl methacrylate) or poly(methyl methacrylate)) in a small amount. Further, a monomer which does not meet the general formula (1) may be partially copolymerized. Even in such a situation, it is possible to achieve the object of the present invention.

As a resin to be used as the binder, it is desirable, from a viewpoint of adequately performing magnetic field orientation, to use a thermoplastic resin capable of being softened at a temperature of 250° C. or less, more specifically a thermoplastic resin having a glass-transition temperature or flow start temperature of 250° C. or less.

In order to disperse the magnet material particles over the thermoplastic resin, it is desirable to add an orientation lubricant in an appropriate amount. As the orientation lubricant, it is desirable to add at least one selected from the group consisting of alcohol, carboxylic acid, ketone, ether, ester, amine, imine, imide, amide, cyanogen, phosphorous functional group, sulfonic acid, a composite material having an unsaturated bond such as a double bond or a triple bond, and a liquid, saturated hydrocarbon composite material. Two or more of them may be used in the form of a mixture. Further, in applying a magnetic field to the mixture of the magnet material particles and the binder, i.e., the composite material, to thereby magnetically orient the magnet material particles, as described later, the mixture is heated to allow such magnetic field orientation treatment to be performed under the condition that the binder component is softened.

By using a binder satisfying the above conditions to serve as the binder to be mixed with the magnet material particles, it is possible to reduce an amount of carbon and an amount of oxygen remaining in a sintered body after sintering. Specifically, the amount of carbon remaining in the sintered body after sintering may be reduced to 2000 ppm or less, preferably 1000 ppm or less. Further, the amount of oxygen remaining in the sintered body after sintering may be reduced to 5000 ppm or less, preferably 2000 ppm or less.

An addition amount of the binder is set to a value capable of, when shaping a slurry-form or heated and melted composite material, filling gaps among the magnet material particles so as to provide improved thickness accuracy to a shaped body obtained as a result of the shaping. For example, the ratio of the binder to a total amount of the magnet material particles and the binder is preferably set in the range of 1 wt % to 40 wt %, more preferably 2 wt % to 30 wt %, still more preferably 3 wt % to 20 wt %, particularly preferably 5 wt % to 15 wt %. Further, the ratio of the resin material to be used in the binder to a total amount of the magnet material particles and the resin material is preferably set in the range of 1 wt % to 30 wt %, more preferably in the range of 2 wt % to 20 wt %, still more preferably in the range of 3 wt % to 15 wt %, particularly preferably in the range of 3.5 wt % to 12 wt %.

In the following embodiments, the mixture of the magnet material particles and the binder, i.e., a composite material 117, is once formed into a sheet-like green shaped body (hereinafter referred to as “green sheet”), and then further formed into a shape for the orientation treatment. For forming the composite material, particularly, into a sheet shape, it is possible to employ: a forming method using, for example, a hot-melt coating process which comprises heating the composite material 117 as the mixture of the mixture of the magnet material particles and the binder, and then forming the melt into a sheet shape: a process which comprises putting the composite material 117 as the mixture of the magnet material particles and the binder into a forming die, and heating the composite material 117 while applying a pressure thereto, to thereby form the composite material into a sheet shape; a process which comprises extruding the composite material by an extruder to thereby form the composite material into a sheet shape; or a slurry coating process which comprises coating a slurry containing the magnet material particles, the binder and an organic solvent, on a substrate, to thereby form the slurry into a sheet shape.

In the following description, description will be made about formation of the green sheet using, particularly, the hot-melt coating process. However, the present invention is not limited to such a specific shaping process. For example, the composite material 117 may be put in a shaping die and shaped under a pressure of 0.1 to 100 MPa while heating at a temperature of room temperature to 300° C. More specifically, in this case, it is possible to employ a process which comprises applying an injection pressure to the composite material 117 heated to a softening temperature, so as to press and charge the composite material 117 into a die, to thereby form the composite material 117 into a sheet shape.

As previously mentioned, a binder is mixed with the magnet material particles finely pulverized using the bead mill 116 or the like to produce a clayey mixture of the magnet material particles and the binder, i.e., the composite material 117. Here, it is possible to use, as the binder, a mixture of a resin and an orientation lubricant, as mentioned above. As one example of the binder, it is preferable to use a thermoplastic resin comprising a polymer containing no oxygen atom in its structure and having a depolymerization property. Further, as the orientation lubricant, it is preferable to add at least one selected from the group consisting of alcohol, carboxylic acid, ketone, ether, ester, amine, imine, imide, amide, cyanogen, phosphorous functional group, sulfonic acid, and a compound having an unsaturated bond such as a double bond or a triple bond.

Among them, it is preferable to use a compound having an unsaturated bond. Examples of this type of compound include a compound having a double bond or a triple bond. Particularly, a compound having a triple bond is preferable, from a viewpoint of being capable of promising an effect of reducing crack in the sintered body.

As the compound having a triple bond, it is preferable to use a compound capable of being easily removed in the aftermentioned calcination treatment. Therefore, the compound to be used is preferably a compound having no hetero atom, particularly preferably a compound consisting only of hydrocarbon. Further, in order to enable stronger interaction with the surfaces of the magnet material particles to thereby bring out a higher orientation lubricating effect, the compound having a triple bond preferably has the triple bond at the end.

With regard to the compound having a triple bond, from a viewpoint of raising the boiling point thereof to facilitate handling, the number of carbon as a constituent element of the compound is preferably 10 or more, more preferably 14 or more, further preferably 16 or more, particularly preferably 18 or more. Although the upper limit of the carbon number is not particularly limited, it may be set to, e.g., 30 or less.

With regard to the compound having a double bond, from a viewpoint of enabling stronger interaction with surfaces of the magnet material particles to bring out a higher orientation lubricating effect, it is preferable to use a compound having a functional group with a hetero atom, and more preferably a compound having a functional group with a hetero atom at the end.

The number of carbon constituting the compound having a double bond is preferably 6 or more, more preferably 10 or more, further preferably 12 or more, particularly preferably 14 or more. Although the upper limit of the carbon number is not particularly limited, it may be set to, e.g., 30 or less.

Further, the compounds having a triple bond and the compound having a double bond may be used in combination.

As previously mentioned, the addition amount of the binder is set such that the ratio of the binder to a total amount of the magnet material particles and the binder in the composite material 117 after the addition is preferably set in the range of 1 wt % to 40 wt %, more preferably 2 wt % to 30 wt %, still more preferably 3 wt % to 20 wt %, particularly preferably 5 wt % to 15 wt %. Further, the ratio of a resin material to be used in the binder to a total amount of the resin material and the magnet material particles is preferably set in the range of 1 wt % to 30 wt %, more preferably 2 wt % to 20 wt %, still more preferably 3 wt % to 15 wt %, particularly preferably 3.5 wt % to 12 wt %.

Here, an addition amount of the orientation lubricant is preferably determined depending on a particle size of the magnet material particles, and it is recommended to increase the addition amount as the particle size of the magnet material particles becomes smaller. Specifically, the addition amount may be set in the range of 0.01 weight parts to 20 weight parts, preferably in the range of 0.3 weight parts to 10 weight parts, more preferably in the range of 0.5 weight parts to 5 weight parts, particularly preferably in the range of 0.8 weight parts to 3 weight parts, with respect to 100 weight parts of the magnet material particles. If the addition amount is excessively small, a dispersion effect becomes poor, possibly leading to deterioration in orientation property. On the other hand, if the addition amount is excessively large, the lubricant is likely to contaminate the magnet material particles. The orientation lubricant added to the magnet material particles adheres onto surfaces of the magnet material particles, and acts to facilitate dispersion of the magnet material particles to provide the clayey mixture, and to assist turning of the magnet material particles in the aftermentioned magnetic field orientation treatment. As a result, it becomes possible to facilitate orientation during application of a magnetic field so as to uniformize respective directions of the easy magnetization axes of the magnet material particles, into approximately the same direction, resulting in an increase in the degree of orientation. Particularly, in the case where the binder is mixed with the magnet material particles, the binder tends to be present around the surfaces of the magnet material particles, so that a frictional force against the magnet material particles during the magnetic field orientation treatment is increased, thereby possibly leading to deterioration in orientation property of the magnet material particles. Thus, the effect arising from addition of the orientation lubricant becomes more important.

Preferably, the mixing of the magnet material particles and the binder is performed in an atmosphere of inert gas such as nitrogen gas, Ar gas or He gas. The mixing of the magnet material particles and the binder is performed, for example, by charging the magnet material particles and the binder into a stirring machine and stirring them using the stirring machine. In this case, with a view to enhancing kneading performance, heating-stirring (stirring under heating) may be performed. It is also desirable to perform the mixing of the magnet material particles and the binder, in an atmosphere of inert gas such as nitrogen gas, Ar gas or He gas. Particularly, in the case where the coarsely-pulverized magnet material particles are finely pulverized by a wet process, the composite material 117 may be obtained by adding the binder to a solvent used for pulverization, without extracting the magnet material particles from the solvent, and, after kneading the resulting mixture, volatilizing the solvent.

Subsequently, the composite material 117 is formed into a sheet shape to prepare the aforementioned green sheet. Specifically, in case of employing the hot-melt coating process, the composite material 117 is heated and melted to have flowability, and then coated on a support substrate 118. Subsequently, the composite material 117 is solidified by heat dissipation to form an elongated strip-shaped green sheet 119 on the support substrate 118 (see FIG. 14D). In this case, although a temperature during heating and melting of the composite material 117 varies depending on a type and an amount of a binder used, it is typically set in the range of 50° C. to 300° C. In this case, it is to be understood that the temperature needs to be set to a value greater than a flow start temperature of the binder used. On the other hand, in case of employing the slurry coating process, a slurry is prepared by dispersing the magnet material particles, the binder and optionally an orientation lubricant for facilitating the orientation, in a large volume of solvent, and the slurry is coated on the support substrate 118. Subsequently, the slurry is subjected to drying to volatilize the solvent therefrom to thereby form an elongated strip-shaped green sheet 119 on the support substrate 118.

Here, as a coating system for the melted composite material 117, it is preferable to use a system having excellent layer thickness controllability, such as a slot-die system or a calender roll system. Particularly, in order to realize high thickness accuracy, it is desirable to use a die system or a comma coating system which is a system having particularly excellent layer thickness controllability, i.e., a system capable of coating a layer having a highly-accurate thickness, on a surface of a substrate. For example, in the slot-die system, the composite material 117 after being heated to have flowability is pressure-fed from a gear pump into a die, and discharged from the die to perform coating. On the other hand, in the calender roll system, the composite material 117 is fed into a nip gap between two heated rolls, in a controlled amount, and the rolls are rotated to coat the composite material 117 melted by heat of the rolls, onto the support substrate 118. As one example of the support substrate 118, it is preferable to use a silicone-treated polyester film. Further, it is preferable to use a defoaming agent or perform vacuum heating defoaming to sufficiently defoam a layer of the coated and developed composite material 117 so as to prevent gas bubbles from remaining in the layer. Alternatively, the melted composite material 117 may be extruded onto the support substrate 118 while being formed into a sheet shape, by an extrusion forming or injection forming, instead of being coated on the support substrate 118, to thereby form the green sheet 119 on the support substrate 118.

In the embodiment depicted in FIGS. 14A, 14B, 14C and 14D, coating of the composite material 117 is performed using a slot-die 120. In a step of forming the green sheet 119 using this slot-the system, it is desirable to actually measure a sheet thickness of the coated green sheet 119, and adjust a nip gap between the slot-the 120 and the support substrate 118, by feedback control based on the actually-measured value. In this case, it is desirable to reduce a variation in an amount of the fluidic composite material 117 to be fed to the slot-die 120, as small as possible, e.g., to ±0.1% or less, and further reduce a variation in coating speed as small as possible, e.g., to ±0.1% or less. This control makes it possible to improve the thickness accuracy of the green sheet 119. As one example, with respect to a design value of 1 mm, the thickness accuracy of the green sheet 119 to be formed may be within ±10%, preferably within ±3%, more preferably within ±1%. In the calender roll system, a film thickness of the composite material 117 to be transferred to the support substrate 118 can be controlled by feedback-controlling calendering conditions based on an actually-measured value in the same manner as that described above.

Preferably, the thickness of the green sheet 119 is set in the range of 0.05 mm to 20 mm. If the thickness is reduced to 0.05 mm or less, it becomes necessary to laminate a plurality of layers so as to achieve a required magnet thickness, resulting in reduced productivity.

Last of all, the green sheet 119 formed on the support substrate 118 by the hot-melt coating process is cut into a size corresponding to a desired magnet size to form a processing sheet piece. The processing sheet piece can be deemed as one example of the rare-earth magnet-forming material, because it will subsequently be set in a sintering die, and serves as a basis for the rare-earth sintered magnet. Further, the green sheet 119 serves as a raw material or a precursor member for the processing sheet piece, i.e., as a basis for the rare-earth sintered magnet. Thus, it is to be understood that the green sheet 119 falls into the concept of the rare-earth magnet-forming material. Further, it is possible to use, as the rare-earth magnet-forming material, not only a shaped body produced by the aforementioned green sheet forming method, but also a shaped body produced by a powder compacting method. This will be specifically described later.

The shape of the processing sheet piece when it is cut out from the green sheet 119 is determined while taking into account the shape of the rare-earth sintered magnets 1 to 4 as a final product, and an actual size of the processing sheet piece just after the cutting-out is determined while taking into account dimensional shrinkage in a pressing direction (pressure application direction) in a sintering step, so as to obtain a given magnet size after the sintering step. The sintering step is performed by pressure-sintering, as described later. Thus, although shrinkage occurs in the processing sheet piece in the pressing direction (the length direction “γ” in FIGS. 1A, 1B, 2A, 2B, 3 and 4), a dimensional difference between the rare-earth sintered magnets 1 to 4 as a final product and the processing sheet piece is in that the length of the rare-earth sintered magnets 1 to 4 as a final along the pressing direction “γ” shrinks to about one-half of the length of a side of the processing sheet along the pressing direction “γ”, because the present invention can suppress anisotropic shrinkage. Here, since the rare-earth sintered magnets 1 to 4 is obtained by sintering the processing sheet piece and magnetizing a resulting sintered body, the sintered body obtained by sintering the processing sheet piece can be considered to have the same shape and size as those of the rare-earth sintered magnets 1 to 4.

### (2) Orientation Step

The processing sheet piece is heated, and the gradually changing magnetic field is applied along the direction of the arrow schematically depicted in FIGS. 1A, 1B, 2A, 2B, 3 and 4. By applying the magnetic field, the easy magnetization axes of the magnet material particles contained in the processing sheet piece are oriented in the direction of the magnetic field or in other words, along the direction of the arrow schematically depicted in FIGS. 1A, 1B, 2A, 2B, 3 and 4. As a result of the heating during the magnetic field application, the binder comprised in the processing sheet piece is softened. This enables the magnet material particles to be turned within the binder, so that the easy magnetization axes of the magnet material particles are oriented in directions along the magnetic field. The surface temperature of the processing sheet piece after the magnetic field is applied (hereinafter, referred to as an “orientation temperature”) is 50° C. to 150° C. or preferably 60° C. to 120° C.

Although a temperature and a time period for heating the processing sheet piece varies depending on the type and amount of the binder used, they may be set, e.g., in range of 40 to 250° C. and in the range of 0.1 to 60 minutes, respectively. In either case, in order to soften the binder comprised in the processing sheet piece, the heating temperature needs to be set to a value equal to or greater than a glass-transition temperature or a flow start temperature of the binder used. Examples of means to heat the processing sheet piece include a heating system using a hot plate, and a system using, as a heat source, a heating medium such as silicone oil. A magnetic field intensity during the magnetic field application may be set in the range of 5000 [Oe] to 150000 [Oe], preferably 10000 [Oe] to 120000 [Oe], particularly preferably 25000 [Oe] to 70000 [Oe]. As a result, the easy magnetization axes of the magnet material particles comprised in the processing sheet piece are oriented along the direction of the magnetic field. This magnetic field application step may be configured such that a magnetic field is simultaneously applied to a plurality of the processing sheet pieces. In this case, the magnetic field may be simultaneously applied, using a die having a plurality of cavities, or a plurality of dies arranged side-by-side. The step of applying a magnetic field to the processing sheet piece may be performed in concurrence with the heating step, or during a period after completion of the heating step and before solidification of the binder of the processing sheet piece.

### (3) Calcination Step

The oriented processing sheet piece in which the easy magnetization axes are oriented is subjected to calcination treatment in a non-oxidizing atmosphere adjusted at an atmospheric pressure, or a pressure greater or less than the atmospheric pressure such as 0.1 MPa to 70 MPa, preferably 1.0 Pa or 1.0 MPa, under a decomposition temperature of the binder, for a holding time of at least 2 hours or more or preferably several hours to several ten hours, e.g., 5 hours. In this treatment, it is recommended to use a hydrogen atmosphere or a mixed gas atmosphere of hydrogen and inert gas. In the case where the calcination treatment is performed in a hydrogen atmosphere, a supply amount of hydrogen during the calcination is set to 2 to 6 L/min, e.g., 5 L/min, but it can be changed as appropriate by a size of a furnace for calcination or a filling amount of the processing sheet piece. The calcination treatment makes it possible to remove the binder, i.e., an organic compound comprised in the composite material obtained by mixing the magnet material particles with the thermoplastic resin, by decomposing the organic compound to monomers through a depolymerization reaction or other reaction, and releasing the monomers. That is, decarbonizing which is treatment for reducing the amount of carbon remaining in the processing sheet piece is performed. Further, it is preferable to perform the calcination treatment under conditions which enable the amount of carbon remaining in the processing sheet piece to become 2000 ppm or less, preferably 1000 ppm or less. This makes it possible to densely sinter the entire processing sheet piece through subsequent sintering treatment to thereby suppress deteriorations in residual magnetic flux density and coercivity. Here, in the case where a pressurization condition during the calcination treatment is set to a pressure greater than atmospheric pressure, it is desirable to set the pressure to 15 MPa or less. Further, the pressurization condition may be set to a pressure greater than atmospheric pressure, more specifically, 0.2 MPa or more. In this case, an effect of reducing the amount of residual carbon can be particularly expected. Although a calcination temperature varies depending on the type of binder, the temperature may be set in the range of 250° C. to 600° C., preferably 300° C. to 550° C., such as 450° C.

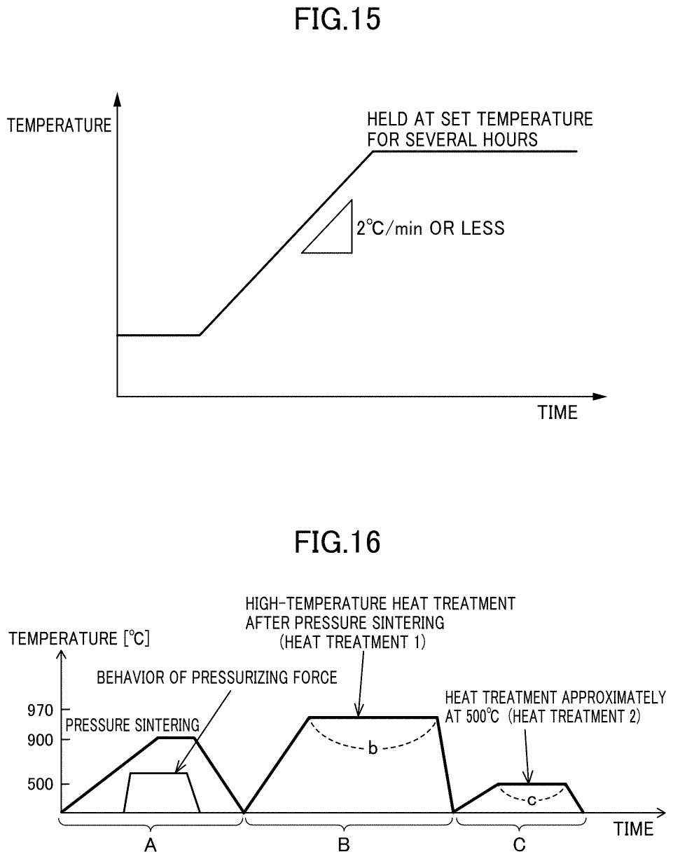

In the above calcination treatment, it is preferable to set a temperature rise rate to a smaller value, as compared to typical sintering treatment of a rare-earth sintered magnet. Specifically, the temperature rise rate may be set to 2° C./min or less, e.g., 1.5° C./min to obtain a preferable result. Thus, the calcination treatment is performed such that the calcination temperature is raised at a given temperature rise rate of 2° C./min or less, as depicted in FIG. 15, and, after reaching a predetermined setup temperature, i.e., the binder decomposition temperature, held at the setup temperature for several hours to several ten hours. As above, the temperature rise rate in the calcination treatment is set to a relatively small value, so that carbon in the processing sheet piece is removed in a step-by-step manner without being rapidly removed. This makes it possible to reduce the amount of residual carbon to a sufficient level to thereby increase the density of a permanent magnet-forming sintered body after sintering. That is, by reducing the amount of residual carbon, it is possible to reduce voids in a permanent magnet. When the temperature rise rate is set to about 2° C./min, as mentioned above, the density of a permanent magnet-forming sintered body after sintering can be increased to 98% or more, e.g., 7.40 g/cm³ or more. As a result, high magnetic properties can expected in a magnet after magnetization.

### (4) Deoiling Step

Deoiling treatment may be performed before the calcination treatment for dissipating oil contents such as the orientation lubricant, plasticizer, etc. A temperature during the deoiling treatment varies depending on the type of oil contained, the temperature may be set in the range of 60° C. to 120° C., preferably in the range of 80° C. to 100° C. In the deoiling treatment, a preferably result can be obtained by setting the temperature rise rate to 5° C./min or less, e.g., 0.7° C./min. A more preferable result can be obtained by performing the deoiling treatment in an atmosphere at a reduced pressure, preferably of 0.01 Pa to 20 Pa, more preferably of 0.1 Pa to 10 Pa. Here, the magnetic properties of the rare-earth sintered magnet as a final product do not vary depending on whether or not the deoiling treatment is performed.

### (5) Sintering Step

FIG. 16 schematically illustrates heat treatment to be performed in a sintering step. In this chart, the horizontal axis and the vertical axis represent time and temperature (° C.), respectively. The sintering process comprises sintering treatment “A”, high-temperature heat treatment “B” (heat treatment 1) to be performed after the sintering treatment “A”, and low-temperature heat treatment “C” (heat treatment 2) to be performed after the high-temperature heat treatment “B”. As described above, by performing particularly the high-temperature heat treatment “B” after the sintering treatment “A”, characteristics of the sintered body obtained via the sintering step “A” and the rare-earth sintered magnet which is an end product can be markedly improved. For convenience, the high-temperature heat treatment “B and the low-temperature heat treatment “C” will be explained as part of the sintering step, however, as is clear from the following explanations, each of these treatments is a mere heat treatment, and is different from pressure sintering in the sintering treatment “A”.

The sintering process is performed in a state in which the processing sheet piece is set inside a preliminarily-prepared sintering die (not depicted) comprising a pair of a male die half and a female die half. The sintering die has a cavity with a shape corresponding to that of the rare-earth sintered magnet as a final product, e.g., a cavity having a cross-section corresponding to that of the processing sheet piece. The processing sheet piece is set inside the sintering die, in a state in which each of the easy magnetization axes thereof is oriented in one plane, i.e., is oriented in one plane defined by the width direction “α” and the thickness direction “β” in FIGS. 1A, 1B, 2A, 2B, 3 and 4.

### <Sintering Treatment>

In the sintering treatment “A”, the calcined processing sheet piece is heated and sintered, while a pressing force is applied thereto by clamping the processing sheet piece between the male die half and the female die half to load a press pressure thereon, that is, the calcined processing sheet piece is subjected to pressure sintering. The pressing direction is set to a direction (the length direction “γ” in FIGS. 1A, 1B, 2A, 2B, 3 and 4) orthogonal to the orientation direction of the easy magnetization axes in the processing sheet piece (the arrow directions in FIGS. 1A, 1B, 2A, 2B, 3 and 4). By applying a pressure in this direction, it is possible to suppress a situation where the orientation of the easy magnetization axes given to the magnet material particles is changed, so that a sintered body having a higher orientation property can be obtained. An initial load when the calcined processing sheet piece is clamped between the male and female die halves is set to a relatively small given pressure, e.g., 0.5 MPa (this initial load is not particularly presented in FIG. 16). However, applying the initial load is not indispensable. In this state, the temperature of the processing sheet piece is raised from room temperature to a pressure-raising initiation temperature at which the raising of the pressure is initiated. Preferably, raising of the temperature is performed at a constant temperature rise rate. The temperature rise rate may be from 3° C./min to 30° C./min, e.g., 20° C./min.

Raising of the pressure is initiated when the temperature reaches, e.g., 300° C. (in the example depicted in FIG. 16, the pressure-raising initiation temperature is indicated at about 700° C.). This is because, when the temperature reaches 300° C., fusion among the magnet material particles comprised in the rare-earth magnet-forming material starts to provide increased strength of the rare-earth magnet-forming material, so that it becomes possible to perform sintering under application of pressure without occurrence of a crack in the rare-earth magnet-forming material. Thus, the raising of the pressure may be initiated when the temperature reaches 300° C. at lowest. However, it is to be understood that the raising of the pressure may be initiated at a temperature of 300° C. or more. Specifically, the raising of the pressure is preferably initiated at a temperature of 500° C. to 900° C., more preferably 700° C. to 850° C. If the pressure-raising initiation temperature is set to an excessively high value, a sintering shrinkage of the rare-earth magnet-forming material causes a gap between the rare-earth magnet-forming material and the sintering die, and thereby the rare-earth magnet-forming material is applied with a pressure in the presence of the gap, leading to the occurrence of a crack or surface irregularity in the rare-earth magnet-forming material. Subsequently, the pressure is raised from the initial load at a constant pressure rise rate, until it reaches a predetermined ultimately achieving load. The pressure rise rate may be, e.g., 14 kPa/sec or more. For example, the ultimately achieving load (pressing force) is from 1 MPa to 30 MPa, preferably, from 3 MPa to 30 MPa, more preferably from 3 MPa to 15 MPa. Particularly, it is preferable that the ultimately achieving load is set to 3 MPa or more. If the ultimately achieving load is set to less than 3 MPa, shrinkage of the processing sheet piece 3 occurs not only in the pressing direction but also in all directions, or the processing sheet piece 3 is undulated. Thus, even if the high-temperature heat treatment “B” is subsequently performed, it is difficult to control a shape or the like of the magnet as a final product. By setting the pressing force to at least 3 MPa or more, it becomes possible to facilitate control of the shape. Even after the pressure reaches the ultimately achieving load, the pressure application will continue until a shrinkage ratio in the pressing direction becomes substantially zero for a given time. The term “given time” here means, e.g., a duration of about 5 minutes in which a change rate per 10 seconds of the shrinkage in the pressing direction is maintained at zero. After confirming that the shrinkage rate in the pressing direction becomes substantially zero for the given time, the pressure application is terminated.

After reaching the pressure-raising initiation temperature, the processing sheet piece 3 is heated at the constant temperature rise rate, until the temperature reaches a predetermined first maximum achieving temperature. Preferably, the first maximum achieving temperature is set to greater than 900° C., e.g., in a reduced-pressure atmosphere at several Pa or less. If the first maximum achieving temperature is set to 900° C. or less, a void is generated in the processing sheet piece 3, and, when the high-temperature heat treatment “B” is subsequently performed, shrinkage of the processing sheet piece 3 occurs not only in the pressing direction but also in all directions, leading to difficulty in controlling a shape or the like of the magnet as a final product. By setting the first maximum achieving temperature to greater than 900° C., it becomes possible to facilitate control of the shape. Preferably, the first maximum achieving temperature is determined while taking into account an average particle size and a composition of the magnet material particles forming the processing sheet piece 3. Generally, when the average particle size is relatively large, the first maximum achieving temperature needs to be set to a higher value. Further, when the content of a rare-earth substance is relatively small, the first maximum achieving temperature needs to be set to a higher value. Further, it is preferable that the pressure reaches the ultimately achieving load before the temperature reaches the first maximum achieving temperature.

By performing the above sintering treatment “A”, it is possible to suppress variation in shrinkage arising during the sintering to obtain a rare-earth sintered magnet-forming sintered body (called a sintered body “1A”, for convenience) having a desired shape. Here, the rare-earth sintered magnets 1 to 4 as a final product have the same size and shape as those of the sintered body 1A. Thus, the rare-earth sintered magnets 1 to 4 depicted in FIGS. 1A, 1B, 2A, 2B, 3 and 4 can be deemed as the sintered body 1A (this is also applied to the aftermentioned sintered bodies “1B”, “1C”). Further, in the sintering treatment “A” the calcined processing sheet piece is sintered by heating it to the sintering temperature, while applying a given magnitude of pressure thereto in a direction (the length direction “γ” in FIGS. 1A, 1B, 2A, 2B, 3 and 4) orthogonal to the orientation direction of the easy magnetization axes (the arrow directions in FIGS. 1 and 2), so that it is possible to suppress a situation where the orientation of the easy magnetization axes given to the magnet material particles is changed. Therefore, this production method makes it possible to obtain a magnet having a higher orientation property. Further, by passing through the sintering treatment “A”, the resin material in the processing sheet piece, such as thermoplastic resin, is almost entirely released (vaporized) by sintering heat, and, even if it remains, the amount of remaining resin is extremely small, so that it is possible to form a sintered body 1A in which the magnet material particles in the processing sheet piece from which the resin has been released are integrally sintered.

As a pressing-sintering technique to be used in the sintering treatment “A”, it is possible to employ any heretofore-known technique such as hot press sintering, hot isostatic press (HIP) sintering, ultrahigh pressure synthesis sintering, gas pressure sintering, or spark plasma sintering (SPS). In particular, it is preferable to employ an inner-heat pressure sintering apparatus in which a heat source is installed inside a sintering furnace capable of applying a pressure in a uniaxial direction.

### <High-Temperature Heat Treatment (Heat Treatment 1)>

The sintered body 1A after being subjected to the sintering treatment “A” is cooled to room temperature, and heated to a given temperature again in the subsequent high-temperature heat treatment “B”. The cooling to room temperature may be natural cooling. The heating is performed in a reduced-pressure atmosphere, more specifically, under a pressure at least lower than the pressing force in the sintering treatment “A”. However, as long as the heating is performed in an atmosphere of inert gas such as argon gas, nitrogen gas, or helium gas, this atmosphere needs not be a reduced-pressure atmosphere. In the high-temperature heat treatment “B”, the temperature of the sintered body 1A is raised to a second maximum achieving temperature preliminarily set for the high-temperature heat treatment, within a given period of time, e.g., within 10 hours, preferably within 5 hours, more preferably within 2 hours. The second maximum achieving temperature for the high-temperature heat treatment is set in the range of greater than 900° C. to 1100° C. Further, the second maximum achieving temperature is set such that a difference from the first maximum achieving temperature reachable in the sintering treatment “A” is within 250° C., preferably within 150° C., more preferably within 100° C. By setting the difference from the first maximum achieving temperature reachable in the sintering treatment “A” to fall within the above range, it is possible to achieve both an increase in density after the sintering and an improvement in magnetic properties by the high-temperature heat treatment “B”. After reaching the second maximum achieving temperature, the second maximum achieving temperature is held for a given period of time (interval (b) depicted in FIG. 16), e.g., for 1 to 50 hours. In the high-temperature heat treatment, the total amount of heat to be given to the sintered body is also important. Thus, this holding time is preferably set in relation to the second maximum achieving temperature. In other words, as long as the total heat amount is not substantially changed, the second maximum achieving temperature and/or the holding time may fluctuate to a certain degree, i.e., it is only necessary to hold the treatment temperature around the second maximum achieving temperature for about 1 to 50 hours. As can be derived from the aftermentioned FIG. 10, the second maximum achieving temperature and the holding time preferably satisfy the following relationship:

−1.13x+1173≥y≥−1.2x+1166(where 1100° C.≥x≥900° C.)

, where x (° C.) denotes the second maximum achieving temperature, and y (hour) denotes the holding time at a temperature around the second maximum achieving temperature.

The setting of the second maximum achieving temperature is also influenced by an average particle size of the magnet material particles after the fine pulverization. For example, when the average particle size is 1 μm, the second maximum achieving temperature is preferably set to greater than 900° C., and, when the average particle size is 5 μm, the second maximum achieving temperature is preferably set to 1100° C. or less. The average particle size is measured using a laser diffraction/scattering particle size distribution measuring device (device name: LA950; manufactured by Horiba Ltd.). Specifically, the magnet material particles after the fine pulverization are slowly oxidized at a relatively low oxidation rate. Then, a few hundred mg of the slowly-oxidized powder is uniformly mixed with silicone oil (product name: KF-9611-1 million cs; manufactured by Shin-Etsu Chemical Co., Ltd.) to form a paste-like mixture. Then, the paste-like mixture is clamped between quartz glass plates to obtain a test sample. (HORIBA paste method). In a graph presenting a particle size distribution (volume %), a value of D50 is defined as the average particle size. In a case where the particle size distribution has a double peak shape, D50 is calculated only with respect to a smaller peak of a particle size to obtain the average particle size.

### <Low-Temperature Heat Treatment (Heat Treatment 2)>

A sintered body (called a sintered body “1B”, for convenience) after being subjected to the high-temperature heat treatment “B” is cooled again to room temperature, and heated to a given temperature again in the subsequent low-temperature heat treatment “C”. The cooling to room temperature may be natural cooling. The heating is performed in a reduced-pressure atmosphere, as with the high-temperature heat treatment “B”. However, as long as the heating is performed in an atmosphere of inert gas such as argon gas, nitrogen gas, or helium gas, this atmosphere needs not be a reduced-pressure atmosphere. In the low-temperature heat treatment “C”, the temperature of the sintered body 1B is raised to a third maximum achieving temperature preliminarily set for the low-temperature heat treatment, within a given period of time, e.g., within 10 hours, preferably within 5 hours, more preferably within 2 hours. The third maximum achieving temperature for the low-temperature heat treatment is set to a temperature less than the second maximum achieving temperature for the high-temperature heat treatment, e.g., in the range of 350° C. to 650° C., preferably 450° C. to 600° C., more preferably 450° C. to 550° C. After reaching the third maximum achieving temperature, the third maximum achieving temperature is held for a given period of time (interval (c) depicted in FIG. 16), e.g., for 2 hours. Immediately after the elapse of the holding time, rapid cooling is preferably performed.

### (6) Magnetization Step

A sintered body (called a sintered body “1C”, for convenience) after being subjected to the low-temperature heat treatment can be magnetized by using the magnetic field applying device 5 which will be described below, for example. However, the magnetic field applying device 5 does not necessarily have to be used, but currently available other general magnetic field applying devices may be also used. Via the magnetization step, the sintered body 1C becomes the rare-earth sintered magnet 1. The magnetized rare-earth sintered magnet 1 is installed on a linear motor, for example, after that.

### 4. MAGNETIC FIELD APPLYING DEVICE

### <Magnetic Field Applying Device for Bipolar Anisotropic Rare-Earth Sintered Magnet>

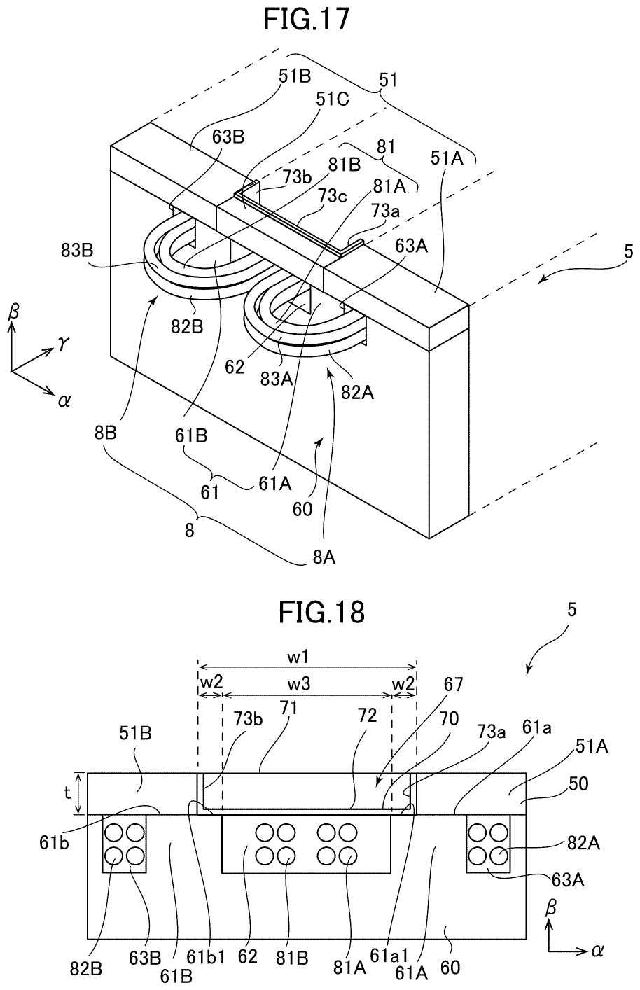

FIGS. 17 and 18 depict an example of the magnetic field applying device 5 which can be used for manufacturing the bipolar anisotropic rare-earth sintered magnet, e.g. the rare-earth sintered magnet 2 depicted in FIGS. 2A and 2B. FIG. 17 is a perspective view on an end portion of the magnetic field applying device 5, and FIG. 18 is a sectional view along the “α-β” direction orthogonal to the length direction “γ” of the magnetic field applying device 5.

The easy magnetization axes of the magnet material particles can be oriented by using the magnetic field applying device 5, and by applying the magnetic field to a work, e.g. a processing sheet piece which is an example of the material for forming the rare-earth magnet. In addition, the rare-earth sintered magnet 2 can be manufactured by magnetizing the rare-earth sintered magnet sintered body by using this device 5. Not only the orientation but also the orientation direction of the easy magnetization axis and the magnetization direction or in other words, the directions of magnetization of the rare-earth sintered magnets 1 to 4 can be easily matched by using the device 5 at magnetization, and the magnetization can be performed with higher accuracy. However, the device 5 does not necessarily have to be used for the orientation and the magnetization.

The magnetic field applying device 5 has a symmetrical shape in the width direction “α” and includes a magnetic body yoke 60 extending in the length direction “γ” and a non-magnetic body yoke 51 comprising a pair of non-magnetic body yokes 51A and 51B extending in the length direction “γ”.

The magnetic body yoke 60 includes a pair of yoke legs 61A and 61B extending in the length direction “γ” and a recess portion 62 formed between the pair of yoke legs 61A and 61B and extending in the length direction “γ”. The pair of yoke legs 61A and 61B has flat upper surfaces 61a and 61b, respectively, and is positioned at an interval “w3” in the width direction “α”.

Each of the pair of non-magnetic body yokes 51A and 51B is disposed on each of the upper surfaces 61a and 61b of the pair of yoke legs 61A and 61B, respectively, and is positioned with respect to the corresponding yoke legs 61A and 61B so that work placing surfaces 61a1 and 61b1 are left with a predetermined width “w2” on a side adjacent to the recess portion 62 of the magnetic body yoke 60 on each of the upper surfaces 61a and 61b of the pair of yoke legs 61A and 61B.

A work placing portion 67 having a cavity with a shape corresponding to a work is formed in order to place the work, e.g. a processing sheet piece and a rare-earth sintered magnet sintered body. The work placing portion 67 is formed in a state across the recess portion 62 of the magnetic body yoke 60 between the pair of non-magnetic body yokes 51A and 51B in the width direction “α”. A die 70 for applying the magnetic field in which the work is accommodated may be installed on the work placing portion 67. The die 70 is specified by a bottom portion 72, side walls 73a and 73b separated from each other in the width direction “α”, and a front wall 73c and a rear wall 73d (not shown) separated from each other in the length direction “γ”. An access opening is provided on an upper part 71 of the die 70 in order to accommodate the work. However, the die 70 is not necessarily needed.

A coil having a substantially linear portion may be used for forming a magnetic field for the work placed on the work placing portion 67. These coils include a first conductor 81 (81A, 81B), a second conductor 82A, and a third conductor 82B, a part of which is disposed along the length direction “γ”, for example. The first conductor 81 is disposed on the recess portion 62, the second conductor 82A is disposed on a side opposite to the recess portion 62 with respect to the yoke leg 61A in the width direction “α”, and the third conductor 82B is disposed on the side opposite to the recess portion 62 with respect to the yoke leg 61B in the width direction “α”. The first conductor 81 may be made of a pair of conductors 81A and 81B separated in the width direction “α”. A direction of a current made to flow through the conductor 81 and a direction of a current made to flow through the conductors 82A and 82B are assumed to be opposite to each other. In this case, the conductor 81A disposed on a side close to the yoke leg 61A in the width direction “α” may be connected to the second conductor 82A through a loop portion 83A, for example, and the conductor 81B disposed on the side close to the yoke 61B in the width direction “α” may be connected to the third conductor 82B through a loop portion 83B, for example. By connecting the conductors, the currents in the opposite directions to each other can be made to flow through these conductors at a time. It is needless to say that a diameter of the conductor is not particularly limited, but the one with a diameter of 1.4 mm can be used, here, from a viewpoint of stabilizing the magnetic field and the like.

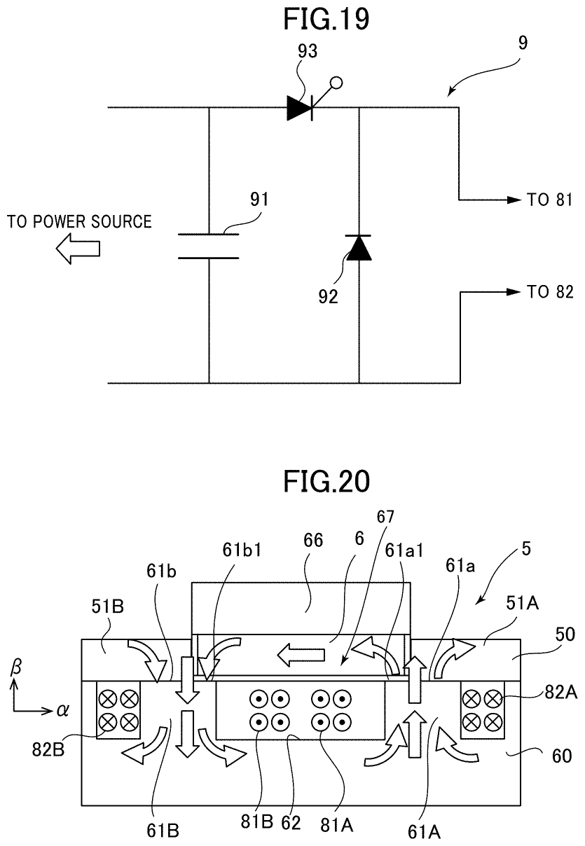

FIG. 19 depicts an example of the electric circuit usable for generating a pulse magnetic field. This electric circuit 9 includes a capacitor 91 and a diode 92 connected in parallel with a power source (not shown) and moreover, a thyristor 93 connected between them in series. The current supplied from the power source is accumulated in the capacitor 91 having a predetermined capacity and then, made to flow as a pulse current having a predetermined peak current (kA) and a predetermined pulse width (ms) for a predetermined number of times between the first conductors 81A and 81B and the second conductors 82A and the third conductor 82B by using the thyristor 93. As a result, a predetermined pulse magnetic field is applied to the work from the conductors 81 and 82. The peak current may be set to approximately 12 kA and the pulse width to approximately 0.7 ms, for example. The peak current is preferably 10 kA to 30 kA and more preferably 10 kA to 20 KA, and the pulse width is preferably 0.3 ms to 500 ms and more preferably 0.5 ms to 100 ms. By containing the peak current and the pulse width within the above ranges, heat generation of the coil can be suppressed while variation in the orientation is suppressed.

FIG. 20 depicts a use example of the device 5 depicted in FIGS. 17 and 18. The pulse magnetic field is applied in a state where a pressure is applied in the thickness direction “β” by pressing an upper portion of the work 6 by a pressing plate 66 or the like, for example, as depicted in FIG. 20. An arrow depicted in FIG. 20 indicates an example of the magnetic field formed by the application of the pulse magnetic field and particularly depicts a magnetic field formed when the current is made to flow in a depicted direction to the conductors 81 and 82 or in more detail, the magnetic field used when the rare-earth sintered magnet 2A depicted in FIG. 2A is to be manufactured. As is obvious, when the rare-earth sintered magnet 2B depicted in FIG. 2B is to be manufactured, it is only necessary to form a magnetic field in a direction opposite to the arrow depicted in FIG. 20 by causing the current to flow through the conductors 81 and 82 in a direction opposite to the direction depicted in FIG. 20. In this case, the conductor 81A and the conductor 82A mainly form the magnetic field orienting or magnetizing one side in the width direction “α” of the work, and the conductor 81B and the conductor 82B mainly form the magnetic field orienting or magnetizing the other side in the width direction “α” of the work and moreover, the conductor 81A and the conductor 81B form the magnetic field orienting or magnetizing the magnetic field penetrating the work in the direction “α”. The magnetic field formed when the current is made to flow through the conductors 81 and 82 in the depicted direction passes, with respect mainly to the work 6 placed on the work placing portion 67, via the portion 61a1 corresponding to the work placing surface of the upper surface 61a of the yoke leg 61A from the yoke leg 61A, through the work 6 placed on the work placing portion 67 in the width direction “α” and reaches the yoke leg 61B via the portion 61b1 corresponding to the work placing surface of the upper surface 61b of the yoke leg 61B.

### <Magnetic Field Applying Device for Tripolar Anisotropic Rare-Earth Sintered Magnet>

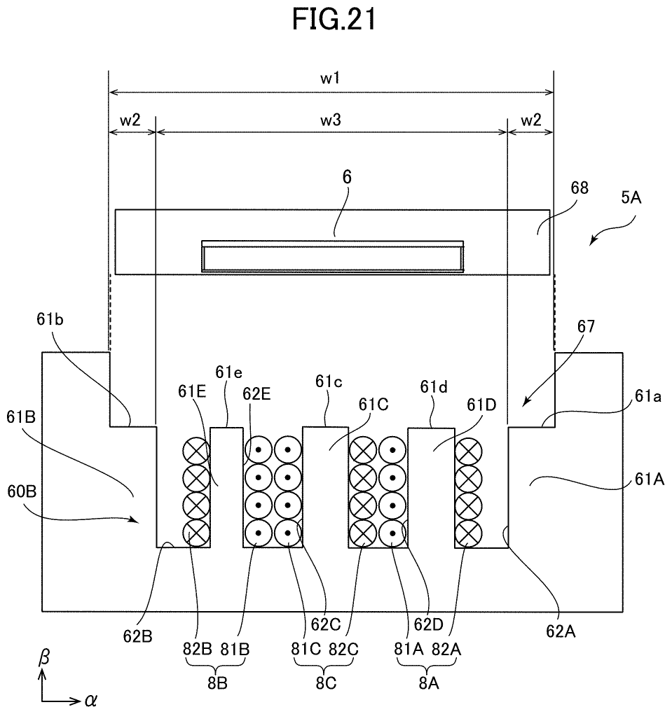

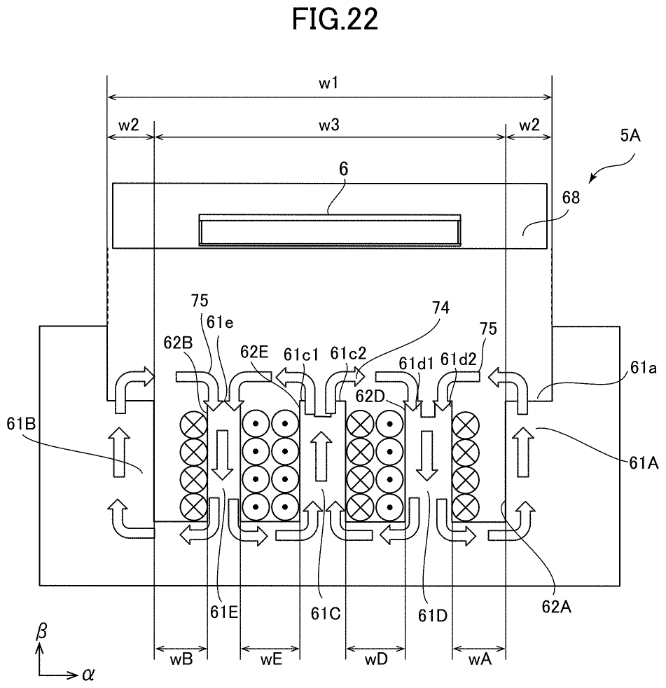

FIGS. 21 and 22 depict an example of a magnetic field applying device 5A which can be used for manufacturing a tripolar anisotropic sintered magnet, e.g. the rare-earth sintered magnet 4 depicted in FIG. 4. These figures are views corresponding to the aforementioned FIGS. 18 and 20, respectively, and similar reference numerals are given to members similar to the members depicted in FIG. 18 and the like.

The magnetic field applying device 5A has a symmetric shape in the width direction “α” and includes a magnetic body yoke 60B extending in the length direction “y. The magnetic body yoke 60B includes a pair of yoke legs 61A and 61B extending in the length direction “γ” similarly to the device 5 depicted in FIG. 18 and the like. The pair of yoke legs 61A and 61B have flat upper surfaces 61a and 61b, respectively, and are positioned at an interval “w3” in the width direction “α”. The magnetic body yoke 60B further includes, in addition to the pair of yoke legs 61A and 61B, a plurality of additional yoke legs 61C, 61D, and 61E positioned at intervals “wA”, “wB”, “wD”, and “wE” in the width direction “α” between them and recess portions 62A, 62B, 62D, and 61E formed between the pair of yoke legs 61A and 61B and the additional yoke legs 61C, 61D, and 61E as well as between the additional yoke legs 61C, 61D, and 61E.

In order to place the work, the work placing portion 67 having a cavity with a shape corresponding to the work is provided on the magnetic body yoke 60B. The work placing portion 67 is formed across the additional yoke legs 61C to 61E and the recess portions 62A, 62B, 62D, and 62E between the pair of magnetic body yokes 61A and 61B in the width direction “α”. The work may be placed on the work placing portion 67 in a state accommodated in a case 68 or the like, for example. However, the case is not necessarily needed.

A substantially linear conductor may be used for forming a magnetic field for the work placed on the work placing portion 67. These conductors may form conductor pairs 8A to 8C, and a part of the conductors forming each of the conductor pairs 8A to 8C is disposed on the recess portions 62A, 62B, 62D, and 62E along the length direction “γ”. The conductor pair 8A is disposed across the recess portions 62A and 62D so as to sandwich the yoke leg 61D from one side and the other side in the width direction “α”, the conductor pair 8C is disposed across the recess portions 62D and 62E so as to sandwich the yoke leg 61C from one side and the other side in the width direction “α”, and the conductor pair 8B is disposed across the recess portions 62E and 62B so as to sandwich the yoke leg 61E from one side and the other side in the width direction “α”. A direction of the current made to flow through the one conductors 81A to 81C forming each of the conductor pairs 8A to 8C and the direction of the current made to flow through the other conductors 82A to 82C are opposite to each other. The conductors forming these conductor pairs 8A to 8C preferably form a loop connected to each other as depicted in the aforementioned FIG. 17. As a result, the current can be easily made to flow in a predetermined direction. It is needless to say that a diameter of the conductor is not particularly limited, but the one with a diameter of 1.4 mm is used, here, from a viewpoint of stabilizing the magnetic field and the like. A current as the basis for the pulse magnetic field can be generated by using the electric circuit depicted in FIG. 19.

The pulse magnetic field is applied in a state where a pressure is applied in the thickness direction “β” by pressing an upper portion of the work 6 by the rectangular case 68, for example, as depicted in FIG. 22. The arrow depicted in FIG. 22 indicates an example of the magnetic field formed by the application of the pulse magnetic field and particularly depicts a magnetic field formed when the current is made to flow in a depicted direction to the conductor pairs 8A to 8C or in more detail, the magnetic field used when the rare-earth sintered magnet 4 depicted in FIG. 4 is manufactured. As is obvious, when a magnet of a polarity exerted in the surface 41 (see FIG. 4) is in an opposite direction is to be manufactured, it is only necessary to form a magnetic field in a direction opposite to the arrow depicted in FIG. 22 by causing the current to flow through the conductor pairs 8A to 8C in a direction opposite to the direction depicted in FIG. 22. In this case, the conductor 82A included in the conductor pair 8A can mainly form the magnetic field orienting or magnetizing one side in the width direction “α” of the work along the thickness direction “β, the coil 82B included in the coil pair 8B can mainly form the magnetic field orienting or magnetizing the other side in the width direction “α” of the work along the thickness direction “β and moreover, the coil 81A included in the coil pair 8A and the coil 82C included in the coil pair 8C as well as the coil 81C included in the coil pair 8C and the coil 81B included in the coil pair 8B can mainly form the magnetic field orienting or magnetizing an intermediate portion in the width direction “α” of the work in the thickness direction “β”, and the magnetic field orienting or magnetizing the work in the thickness direction “β”, respectively. The magnetic field is formed between the upper surfaces of the adjacent yoke legs 61A to 61D when the current is made to flow through the coil pairs 8A to 8C. A magnetic field 74 from the upper surface of the yoke leg toward the upper surface of another yoke leg can be also formed or to the contrary, a magnetic field 75 toward the upper surface of the yoke leg from the upper surface of another yoke leg can be also formed by the direction of the current made to flow through the coil pairs 8A to 8C.

Particularly in the example depicted in FIG. 22, with respect to the yoke leg 61D, the magnetic field 75 is formed from the upper surface 61a of the yoke leg 61A adjacent to the yoke leg 61D toward the yoke leg 61D and from the yoke leg 61C adjacent to the yoke leg 61D toward the yoke leg 61D. Moreover, the magnetic field 74 is formed from the yoke leg 61C toward the yoke leg 61D adjacent to the yoke leg 61C and from the yoke leg 61C toward the upper surface 61e of the yoke leg 61E adjacent to the yoke leg 61C. Moreover, with respect to the yoke leg 61E, the magnetic field 75 is formed from the upper surface 61b of the yoke leg 61B adjacent to the yoke leg 61E toward the upper surface 16e of the yoke leg 61E and from the yoke leg 61C adjacent to the yoke leg 61E toward the upper surface 61e of the yoke leg 61E. The magnetic field 74 from the upper surface of the yoke leg toward the upper surface of another yoke leg and to the contrary, the magnetic field 75 from the upper surface of another yoke leg toward the upper surface of the yoke leg are formed alternately in the width direction “α” between the adjacent pair of yoke legs 61A and 61B and the additional yoke legs 61C, 61D, and 61E. By forming these magnetic fields, a magnetic field passing the work in the width direction “α” is formed on a part of the work located between the yoke legs. In the device 5A, the non-magnetic body yoke is not used, but similarly to the device depicted in FIG. 18 and the like, it can be used in the relation with the pair of yoke legs 61A and 61B. Thus, the device 5A does not exclude use of the non-magnetic body yoke.

### <Magnetic Field Applying Device for Unipolar Anisotropic Rare-Earth Sintered Magnet Sintered Body>

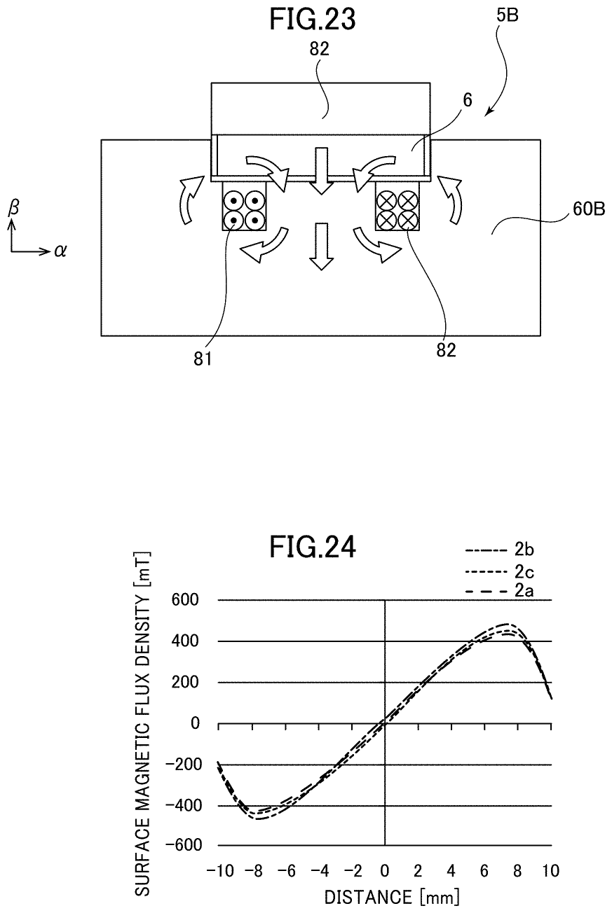

FIG. 23 depicts an example of a magnetic field applying device 5B which can be used for manufacturing the rare-earth sintered magnet 1 depicted in FIGS. 1A and 1B. FIG. 23 is a view corresponding to the aforementioned FIG. 20, and similar reference numerals are given to members similar to the members depicted in FIG. 20 and the like. This device 5B can be considered to be the one with some change added to the device 5. Here, only a pair of coils (81, 82) is used, and the non-magnetic body yoke 51 is not used. An arrow depicted in FIG. 23 depicts an example of the magnetic field formed by the application of the pulse magnetic field and depicts a magnetic field generated when a current is made to flow through the coils 81 and 82 included in the pair of coils in the depicted direction or in more detail, the magnetic field used when the rare-earth sintered magnet 1A depicted in FIG. 1A is to be manufactured. As is obvious, when the rare-earth sintered magnet 1B depicted in FIG. 1B is to be manufactured, it is only necessary to form a magnetic field in a direction opposite to the arrow depicted in FIG. 23 by causing the current to flow through the coils 81 and 82 in the direction opposite to the direction depicted in FIG. 21.

### 5. EXAMPLE

With respect to the rare-earth sintered magnet 2A depicted in FIG. 2A manufactured by using the magnetic field applying device 5 depicted in FIGS. 17 to 20, the maximum surface magnetic flux densities “D1” and “D2” (T) of each of the one surface 21 and the other surface 22, the magnetic flux density ratio (D1/D2), the maximum surface magnetic flux density per unit thickness on the one surface 21 and the axial symmetry were analyzed and evaluated.

### (1) Maximum Surface Magnetic Flux Density (T)

This is a value “D1” (T) of the surface magnetic flux density which becomes the maximum at a position away from the one surface 21 in a direction opposite to the other surface 22 only by 1 mm in the thickness direction “β”. Moreover, this is a value “D2” (T) of the surface magnetic flux density which becomes the maximum at a position away from the other surface 22 in a direction opposite to the one surface 21 only by 1 mm in the thickness direction “β”. In general, the surface magnetic flux density “D1” is preferably larger, while the surface magnetic flux density “D2” is preferably smaller. As a result, the leakage magnetic flux by the magnetic circuit connecting the one surface of the magnet and the other surface faced with that can be reduced. The value of the surface magnetic flux density is a component in parallel with a normal line direction with respect to the surface 21. In the measurement, a three-dimensional magnetic-field vector distribution measuring device (MTX-5R) by IMS was used.

### (2) Magnetic Flux Density Ratio (D1/D2)

This is a ratio (D1/D2) between the maximum surface magnetic flux density “D1” on the one surface 21 and the maximum surface magnetic flux density “D2” on the other surface 22 acquired in the above (1). If the magnetic flux density ratio is larger than 1, it means that the maximum surface magnetic flux density on the one surface 21 is larger than the maximum surface magnetic flux density on the other surface 22. When the magnetic flux density ratio has a large value, it has an effect that the yoke is not necessary on the other surface, and for that purpose, the value needs to be at least 3 or more and preferably 4 or more.

### (3) Maximum Surface Magnetic Flux Density Per Unit Thickness (T/mm)

This is a value obtained by dividing the maximum surface magnetic flux density “D1” (T) on the one surface 21 acquired in the above (1) by the thickness dimension “t” (mm) in the thickness direction “β” between the one surface 21 and the other surface 22. This value can be an index for specifying a thickness dimension of the rare-earth sintered magnet from a viewpoint of efficient improvement of the maximum surface magnetic flux density “D1”, and the value is preferably larger. Since the maximum surface magnetic flux density becomes larger as its thickness increases, the thickness should be made larger from a viewpoint of increasing the maximum surface magnetic flux density, but since the maximum surface magnetic flux density per unit thickness becomes smaller as the thickness increases, the thickness should not be made much larger from a viewpoint of the efficient improvement of the maximum surface magnetic flux density D1 on the first surface. An optimal thickness dimension can be determined by using this index in order to efficiently improve the maximum surface magnetic flux density while the maximum surface magnetic flux density is held at a desired value.

### (4) Axial Symmetry

This is a characteristic obtained by acquiring the surface magnetic flux density distribution in the width direction “α” at a plurality of positions in the length direction “γ” and by comparing the surface magnetic flux density distributions acquired at the plurality of positions with each other. If the value of axial symmetry is small, it means that the symmetry is excellent. Control of the linear motor or the like can be facilitated, and thrust fluctuation can be suppressed, for example, by improving symmetry.

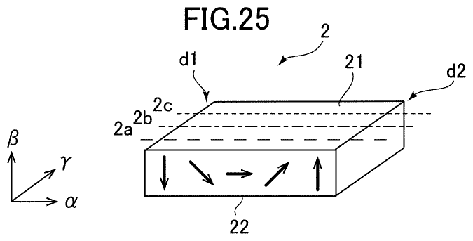

In order to acquire the axial symmetry, as a preparation stage, first, FIG. 24 corresponding to FIG. 7 is created in relation to the one surface 21. This view was created by obtaining values of the plurality of surface magnetic flux densities through sequential sampling on a length portion from one end portion “d1” to the other end portion “d2” in the width direction “α” of each of lines 2a to 2c (see FIG. 25) which divide the rare-earth sintered magnet 2 into four equal parts in the length direction “γ” by shifting by 0.004 mm each in the width direction “α” and by plotting the plurality of obtained values. Here, the same device as that in the above (1) was used for the measurement of the surface magnetic flux density, and the surface magnetic flux density was measured at a position away from the one surface 21 only by 1 mm similarly to the above (1).

Subsequently, a value of axial symmetry was acquired by digitalizing a rate of concordance between the surface magnetic flux density on the line 2a and the surface magnetic flux density on the line 2c by using a residual sum of squares for each distance at the 0.004-mm interval from the end portion “d1” in the width direction “α”. The following equation was used for the digitization:

$$Symmetry = \frac{{\{ {\sum }_{n = 0}^{N} {( \vert Fa ( {x}_{n} ) \vert - \vert Fb ( {x}_{n} ) \vert )}^{2} \}}^{0.5}}{N} \qquad [ Math . 1 ]$$

where N denotes the total sum of sampling, n denotes the n-th sampling, Xn denotes a distance from the end portion “d1” at the n-th sampling or in more detail, 0.004×n (mm), a function Fa (Xn) is a value of the surface magnetic flux density at Xn on the line 2a or in more detail, a value of the surface magnetic flux density at a position away from the end portion “d1” only by “Xn”, and similarly, a function Fb (Xn) is a value of the surface magnetic flux density at Xn on the line 2c or in more detail, a value of the surface magnetic flux density at a position away from the end portion “d1” only by “Xn”, respectively.

An analysis result is depicted in the following Table 1:

TABLE 1

| | | | | | | | | | Maximum | Maximum | | Maximum | |
|---|---|---|---|---|---|---|---|---|---|---|---|---|---|
| | | | | | | | | | surface | surface | | surface | |
| | | | | | | | | | magnetic | magnetic | | magnetic | |
| | Thick- | | | | | Orienta- | | | flux | flux | Magnetic | flux | |
| | ness | | | | Number | tion | | | density | density on | flux | density | |
| | dimen- | Width | Capacitor | Charge | of pulse | temp- | Pulse | Peak | on one | the other | density | per unit | |
| | sion (t) | (W) | capacity | voltage | applying | erature | width | current | surface | surface | ratio | thickness | Axial |
| | (mm) | (mm) | (uF) | (V) | times | (° C.) | (ms) | (kA) | (D1) (T) | (D2) (T) | (D1/D2) | (T/mm) | symmetry |
| Inventive | 4 | 19 | 5000 | 755 | 3 | 120 | 0.25 | 12.4 | 0.473 | 0.095 | 5.0 | 0.12 | 0.11 |
| Example 1 | | | | | | | | | | | | | |
| Inventive | 3 | 19 | 1000 | 1300 | 3 | 120 | 1.5 | 13.0 | 0.434 | 0.083 | 5.2 | 0.14 | 0.58 |
| Example 2 | | | | | | | | | | | | | |
| Inventive | 2 | 19 | 1000 | 1300 | 3 | 120 | 1.5 | 13.0 | 0.337 | 0.073 | 4.6 | 0.17 | 0.26 |
| Example 3 | | | | | | | | | | | | | |
| Inventive | 6 | 19 | 1000 | 1300 | 3 | 120 | 1.5 | 13.0 | 0.547 | 0.071 | 7.7 | 0.09 | 0.11 |
| Example 4 | | | | | | | | | | | | | |
| Inventive | 10 | 19 | 1000 | 1300 | 3 | 120 | 1.5 | 13.0 | 0.591 | 0.051 | 11.6 | 0.06 | 0.42 |
| Example 5 | | | | | | | | | | | | | |

### Inventive Example 1

The rare-earth sintered magnet 2A depicted in FIG. 2A was fabricated under the conditions below by using the magnetic field applying device 5 depicted in FIGS. 17 to 20, and the maximum surface magnetic flux densities “D1” (T) and “D2” (T) on each of the one surface 21 and the other surface 22, the magnetic flux density ratio (D1/D2), the maximum surface magnetic flux density (T/mm) per unit thickness on the one surface 21, and the axial symmetry were analyzed and evaluated.

### <Coarse Pulverization>

At room temperature, hydrogen was adsorbed onto an alloy obtained by a strip casting process, and the resulting alloy was held under a pressure of 0.85 MPa for one day. Subsequently, the resulting alloy was further held under a pressure of 0.2 MPa for one day, while being cooled by liquefied Ar, thereby inducing hydrogen cracking. The alloy had a composition “comprising Nd: 25.25 wt %, Pr: 6.75 wt %, B: 1.01 wt %, Ga: 0.13 wt %, Nb: 0.2 wt %, Co: 2.0 wt %, Cu: 0.13 wt %, Al: 0.1 wt %, a remainder including Fe, and other unavoidable impurities”.

### <Fine Pulverization>

1 weight part of methyl caproate was mixed with 100 weight parts of the coarsely-pulverized coarse alloy powder, and the resulting mixture was fed to a helium jet mill pulverizer (device name: PJM-80HE, manufactured by Nippon Pneumatic Mfg. Co., Ltd. (NPK)) to pulverize the hydrogen-cracked coarse alloy powder. The resulting pulverized alloy particles were separated and collected by a cyclone system, and an ultrafine powder was removed. During the pulverization, a feed rate of the mixture was set to 4.3 kg/h, and an introduction pressure and a flow rate of He gas were set, respectively, to 0.6 MPa and 1.3 m³/min. Further, an oxygen concentration was 1 ppm or less, and a dew point was −75° C. or less. The pulverized fine particles had an average particle size of about 3 μm.

### <Dehydrogenation of Magnetic Powder>

The magnetic powder was dehydrogenated by raising a temperature of the magnetic powder subjected to the fine pulverization under a reduced pressure from a room temperature to 180° C. in 0.5 hours and then, by holding it for 5 hours.

### <Kneading>

With respect to 100 weight parts of the dehydrogenated magnetic powder, 4 weight parts of an SIS resin (Quintac 3390: by Zeon Corporation) which is a styrene-isoprene block copolymer, 1.5 weight parts of 1-octadecyne, and 4.5 weight parts of 1-octadecene were mixed and kneaded so as to obtain a work (processing sheet) in which the magnetic powder and an organic substance were mixed.

### <Molding>

The work was filled in a die having a cavity of a width of 19 mm, a thickness of 4 mm, and a length of 14 mm and molded by being held at 80° C. for 3 minutes and by being pressurized at 3 MPa.

### <Magnetic Field Orientation>

The orientation processing was executed by installing the molded work in the magnetic field applying device (orientation instrument) 5 depicted in FIG. 17 and the like and by applying a pulse magnetic field to the work under conditions of a capacitor capacity of 5000 μF and a charge voltage of 755 V. A maximum current when the magnetic field was applied was 12.4 kV, the pulse width was 0.25 ms, and the number of pulse magnetic field applying times was continuously three times. A work surface temperature after the pulse magnetic field was applied three times, that is, the orientation temperature was 120° C.

### <Calcination (Decarbonization) Step>

Decarbonization processing was executed to the work after the pulse magnetic field was applied under a hydrogen pressurized atmosphere of 0.8 MPa. The temperature was raised from the room temperature to 500° C. in 8 h at a temperature rise speed of approximately 1° C./min and was held for 2 h. A hydrogen flowrate was 2 to 3 L/min.

### <Sintering>

A sample after the decarbonization step was contained in a sintering die made of graphite. The sintering die made of graphite had a hole formed for sliding so as to enable pressure application in a length direction of the sample, and a pressing pin made of graphite for pressure application contained in the hole for sliding was inserted thereinto.

The sample contained in the sintering die made of graphite was subjected to sintering by a pressure sintering device in the length direction of the sample under a reduced pressure atmosphere by applying pressure to the graphite pin for pressing. As sintering conditions, pressure sintering was performed such that temperature was raised from the room temperature to 700° C. in 35 minutes while a load of 0.7 MPa was applied under the reduced pressure atmosphere and then, the temperature was raised to 950° C. in 13 minutes while a load of 6.6 MPa was applied and held in that state for 15 minutes.

### <Annealing (High-Temperature Heat Treatment and Low-Temperature Heat Treatment)>

The temperature of the sintered body cooled to the room temperature was raised from the room temperature to 1000° C. in 1.5 hours and held for 4 hours. After that, after being cooled to the room temperature, the temperature was raised again to 500° C. in 0.5 hours and then, held at 500° C. for 1 hour and quenched for annealing. The annealing step was performed under the reduced pressure atmosphere.

### <Polishing>

The annealed sintered body was shaped by a polishing machine to have a sintered body with a dimension of a width of 19 mm, a thickness of 4 mm, and a length of 6.8 mm.

### <Magnetization>

The pulse magnetic field was applied once to the polished sintered body by using the magnetic field applying device 5 used for the magnetic field orientation so as to perform magnetization and to have a bipolar rectangular anisotropic rare-earth sintered magnet. The application of the pulse magnetic field was performed under conditions of the capacitor capacity of 1000 μF and the charge voltage of 1300 V. The maximum current value at that time was 13 kA and the pulse width were 1.5 ms.

With regard to the rare-earth sintered magnet fabricated with the conditions above, the results of sampling with the same procedures as the procedures described in the above “(4) Axial symmetry” were plotted, and the result depicted in the aforementioned FIG. 7 were obtained for the surface magnetic flux density.

When a linear motor used as industrial motors for manufacturing a semiconductor and a liquid crystal, a shaver and the like is to be driven, for example, the surface magnetic flux density on the one surface (principal surface) needs to be 0.2T or more at the minimum, preferably 0.25T or more, more preferably 0.3T or more and further preferably 0.4T or more. According to Inventive Example 1, the maximum surface magnetic flux density on the one surface (principal surface) 21 or in more detail, a maximum value (absolute value) D1 of the surface magnetic flux density at a center (line 2b in FIG. 25) in the length direction “β” was 0.473T, which sufficiently exceeded 0.2T. Therefore, it is sufficient for driving the linear motor used for the above objectives, for example.

Moreover, when this type of linear motor is to be driven, the surface magnetic flux density on the other surface needs to be, though depending on the surface magnetic flux density on the principal surface, 0.2T or less at the maximum, preferably 0.15T or less, more preferably 0.1T or less or further preferably 0.095T or less. According to Inventive Example 1, the maximum value (absolute value) D2 of the maximum surface magnetic flux density on the other surface (second surface) is 0.095T, and the surface magnetic flux density sufficiently below 0.2T was obtained.

Moreover, since the magnetic flux density ratio acquired by using them was 5.0 (≈0.473/0.095), it can be considered that the magnetic flux having practically useful surface magnetic flux density is concentrated only in one surface or mainly in one surface in this rare-earth sintered magnet. Therefore, the leakage magnetic flux is small, and there is no need to provide a yoke on the other surface.

The maximum surface magnetic flux density per unit thickness is considered to be practically needed to be at least 0.04 T/mm or more, preferably 0.06 T/mm or more, more preferably 0.08 T/mm or more, further preferably 0.1 T/mm or more, furthermore preferably 0.12 T/mm or more, and an upper limit is not particularly limited, but it can be 0.5 T/mm or less, for example. According to Inventive Example 1, the maximum surface magnetic flux density per unit thickness was 0.12 (≈0.473/4) T/mm, which is a sufficient value from the viewpoint of efficient improvement of the maximum surface magnetic flux density “D1”.

The axial symmetry is preferably 0.7 or less, more preferably 0.6 or less, further preferably 0.5 or less, and furthermore preferably 0.3 or less. According to Inventive Example 1, the axial symmetry was 0.11, which is a value sufficiently below 0.7 and sufficiently symmetric in the length direction “γ”. This can be considered to be because orientation accuracy could be improved by realizing the pulse magnetic field orientation with respect to the work, and a sintering operation can be performed by pressure sintering, while holding the work.

### Inventive Examples 2, 3, 4, and 5

The same operation as that in Inventive Example 1 was performed except that the conditions described in Table 1 were changed. Particularly in Inventive Examples 2 to 5, the conditions were all the same except that the thickness of the rare-earth sintered magnet was changed.

With regard to the rare-earth sintered magnet with the thickness of 3 mm fabricated in accordance with Inventive Example 2, the maximum surface magnetic flux density D1 on the first surface was 0.434 (T), the maximum value (absolute value) D2 of the maximum surface magnetic flux density on the second surface was 0.083 (T), the magnetic flux density ratio was 5.2, and the maximum surface magnetic flux density per unit thickness was 0.14 (T/mm), and the result of these values was as good as that of Inventive Example 1. The axial symmetry was 0.58 and was slightly poorer in the axial symmetry in the length direction “γ” as compared with Inventive Example 1.

Moreover, with regard to the rare-earth sintered magnet with the thickness of 2 mm fabricated in accordance with Inventive Example 3, the maximum surface magnetic flux density D1 on the first surface was 0.337 (T), the maximum value (absolute value) D2 of the maximum surface magnetic flux density on the second surface was 0.073 (T), the magnetic flux density ratio was 4.6, and the maximum surface magnetic flux density per unit thickness was 0.17 (T/mm), and the result of these values was as good as that of Inventive Example 1 similarly to Inventive Example 2. The axial symmetry was 0.26 and was slightly poorer in the axial symmetry in the length direction “γ” as compared with Inventive Example 1.

With regard to the rare-earth sintered magnet with the thickness of 6 mm fabricated in accordance with Inventive Example 4, the maximum surface magnetic flux density D1 on the first surface was 0.547 (T), the maximum value (absolute value) D2 of the maximum surface magnetic flux density on the second surface was 0.071 (T), the magnetic flux density ratio was 7.7, and the maximum surface magnetic flux density per unit thickness was 0.09 (T/mm).

With regard to the rare-earth sintered magnet with the thickness of 10 mm fabricated in accordance with Inventive Example 5, the maximum surface magnetic flux density D1 on the first surface was 0.591 (T), the maximum value (absolute value) D2 of the maximum surface magnetic flux density on the second surface was 0.051 (T), the magnetic flux density ratio was 11.6, and the maximum surface magnetic flux density per unit thickness was 0.06 (T/mm).

As is also obvious from these results, the maximum surface magnetic flux density per unit thickness becomes smaller as the thickness becomes larger, while the maximum surface magnetic flux density becomes larger as the thickness becomes larger. By considering a balance between the maximum surface magnetic flux density per unit thickness and the maximum surface magnetic flux density, the thickness of the rare-earth sintered magnet is preferably 10 mm or less and more preferably 8 mm or less. If the thickness of the rare-earth sintered magnet is larger than 10 mm (Inventive Example 5), the maximum surface magnetic flux density D1 on the first surface becomes larger, but the maximum surface magnetic flux density per unit thickness becomes smaller than 0.04 T/mm and as a result, it is likely that efficient improvement of the maximum surface magnetic flux density D1 on the first surface becomes difficult.

As is obvious from the results of these Inventive Examples 1 to 5, the magnetic flux having practically useful surface magnetic flux density is concentrated only in the one surface 21 in the thickness direction “δ” or mainly in the one surface in the thickness direction in the rare-earth sintered magnets 1 to 5 of the present invention, while the magnetic flux is scarce on the other surface 22, and at least the relationship of the magnetic flux density ratio (D1/D2)≥4 is satisfied between the maximum surface magnetic flux density “D1” on the one surface 21 and the maximum surface magnetic flux density “D2” 22 on the other surface. Though the upper limit of this magnetic flux density ratio is not particularly limited, but it can be 8 or more or 10 or more, and it is known from the results of Inventive Examples that the upper limit can be increased to at least approximately 12.

Though detailed results are not particularly shown for the rare-earth sintered magnet sintered body before magnetization, the rare-earth sintered magnet sintered body can be considered to be similar to the rare-earth sintered magnet. In more detail, the rare-earth sintered magnet sintered body has not been magnetized yet, but with regard to the magnet material particles contained in that, the magnet material particles having the easy magnetization axes oriented in the direction crossing the one surfaces 11 and 21 in the thickness direction “β” and the magnet material particles having the easy magnetization axes oriented in the direction crossing the other surfaces 12 and 22 in the thickness direction “β” generate the magnetic flux having a predetermined surface magnetic flux density through the magnetic field orientation, and since it is obvious that the ratio of these surface magnetic flux densities corresponds to that of the rare-earth sintered magnet, at least the relationship of (D1′/D2′)≥4 is satisfied between the maximum surface magnetic flux density (D1′) of the magnet material particles having the easy magnetization axes oriented in the direction crossing the one surface 11 in the one surface 11 and the maximum surface magnetic flux density (D2′) of the magnet material particles having the easy magnetization axes oriented in the direction crossing the other surface 12 in the other surface 12 similarly to the rare-earth sintered magnet.

The present invention is not limited to the aforementioned embodiments but is capable of other various changes. Therefore, the drawings and the description are only exemplification and are not binding.

### REFERENCE SIGNS LIST

11 one surface (first surface)
12 the other surface (second surface)
13 side surface
14 end surface (plane)
21 one surface (first surface)
21a one side
21b the other side
22 the other surface (second surface)
23 side surface
24 end surface (plane)

1. A rare-earth sintered magnet having a configuration in which a large number of magnet material particles including a rare-earth substance and each having an axis of easy magnetization are integrally sintered,
the rare-earth sintered magnet having a three-dimensional shape with a width direction, a thickness direction, and a length direction and including a first surface and a second surface opposing each other in the thickness direction, wherein
in a plane in parallel with the width direction and the thickness direction, the magnet material particles are oriented such that an orientation direction of the easy magnetization axis is gradually changed in a region from each of both end portions in the width direction toward a center portion in the width direction; and
a maximum surface magnetic flux density (D1) on the first surface and the maximum surface magnetic flux density (D2) on the second surface satisfy a relationship of (D1/D2)≥4.

2. The rare-earth sintered magnet according to claim 1, wherein
the orientation direction of the easy magnetization axis is different between each of the both end portions in the width direction and the center portion in the width direction by 90°±5° or 180°±5°.

3. The rare-earth sintered magnet according to claim 2, wherein
the orientation direction of the easy magnetization axis is different between each of the both end portions in the width direction and the center portion in the width direction by 90°±5°, and only an N-pole or an S-pole is generated in the first surface.

4. The rare-earth sintered magnet according to claim 2, wherein
the orientation direction of the easy magnetization axis is different between each of the both end portions in the width direction and the center portion in the width direction by 180°±5°, and the N-pole or the S-pole is generated on the one side in the width direction of the first surface, while the S-pole or the N-pole with polarity opposite to that on the one side is generated on the other side in the width direction of the first surface.

5. The rare-earth sintered magnet according to claim 1, wherein
a maximum surface magnetic flux density on the first surface is 0.25T or more.

6. The rare-earth sintered magnet according to claim 1, wherein
a maximum surface magnetic flux density on the second surface is 0.15T or less.

7. The rare-earth sintered magnet according to claim 1, wherein
the maximum surface magnetic flux density per unit thickness obtained by dividing the maximum surface magnetic flux density in the first surface by a thickness dimension in the thickness direction between the first surface and the second surface is 0.06T/mm or more.

8. The rare-earth sintered magnet according to claim 1, wherein
axial symmetry obtained by obtaining the surface magnetic flux density distribution in the width direction at a plurality of positions in the length direction and by comparing the surface magnetic flux density distributions obtained at the plurality of positions with each other is 0.7 or less.

9. The rare-earth sintered magnet according to claim 1, wherein
a thickness dimension in the thickness direction is 10 mm or less.

10. The rare-earth sintered magnet according to claim 1, wherein
the width dimension in the width direction is 40 mm or less.

11. The rare-earth sintered magnet according to claim 1, wherein
the rare-earth sintered magnet has a cuboid shape.

12. A rare-earth sintered magnet sintered body having a configuration in which a large number of magnet material particles including a rare-earth substance and each having an axis of easy magnetization are integrally sintered,
the rare-earth sintered magnet sintered body having a three-dimensional shape with a width direction, a thickness direction, and a length direction and including a first surface and a second surface opposing each other in the thickness direction, wherein
in a plane in parallel with the width direction and the thickness direction, the magnet material particles are oriented such that the orientation direction of the easy magnetization axis is gradually changed in a region from each of the both end portions in the width direction toward the center portion in the width direction; and
the magnet material particles are oriented so that the maximum surface magnetic flux density (D1′) of the magnet material particles having the easy magnetization axis oriented in a direction crossing the first surface on the first surface and the maximum surface magnetic flux density (D2′) of the magnet material particles having the easy magnetization axis oriented in a direction crossing the second surface on the second surface satisfy a relationship of (D1′/D2′)≥4.

13. The rare-earth sintered magnet sintered body according to claim 12, wherein
the orientation direction of the easy magnetization axis is different between each of the both end portions in the width direction and the center portion in the width direction by 90°±5° or 180°±5°.

14. The rare-earth sintered magnet sintered body according to claim 13, wherein
the orientation direction of the easy magnetization axis is different between each of the both end portions in the width direction and the center portion in the width direction by 90°±5°, and only the N-pole or the S-pole is generated in the first surface.

15. The rare-earth sintered magnet sintered body according to claim 13, wherein
the orientation direction of the easy magnetization axis is different between each of the both end portions in the width direction and the center portion in the width direction by 180°±5°, and the N-pole or the S-pole is generated on the one side in the width direction of the first surface, while the S-pole or the N-pole with polarity opposite to that on the one side is generated on the other side in the width direction of the first surface.

16. The rare-earth sintered magnet sintered body according to claim 12, wherein
a thickness dimension in the thickness direction is 10 mm or less.

17. The rare-earth sintered magnet sintered body according to claim 12, wherein
the width dimension in the width direction is 40 mm or less.

18. A magnetic field applying device for applying a magnetic field to a work, comprising:
a magnetic body yoke including a pair of yoke legs located at an interval in a width direction and a recess portion formed between the pair of yoke legs, wherein
on a side adjacent to the recess portion on each of upper surfaces of the pair of yoke legs, a work placing surface with a predetermined width is formed, and a work placing portion across the recess portion of the magnetic body yoke is formed between the pair of yoke legs.

19. The magnetic field applying device according to claim 18, further comprising:
a pair of non-magnetic body yokes disposed on the upper surfaces of the pair of yoke legs, wherein
each of the pair of non-magnetic body yokes is positioned on each of the upper surfaces of the pair of yoke legs with respect to the corresponding yoke legs so that the work placing surface with the predetermined width is left on a side adjacent to the recess portion of the magnetic body yoke, and a work placing portion across the recess portion of the magnetic body yoke is formed between the pair of non-magnetic body yokes; and
the magnetic field is formed with respect to the work placed on the work placing portion from one of the pair of yoke legs via a portion corresponding to the work placing surface on the upper surface of the one of yoke legs, passing through the work placed on the work placing portion in the width direction, via a portion corresponding to the work placing surface on the upper surface of the other of the pair of yoke legs and reaching the other yoke leg.

20. The magnetic field applying device according to claim 19, wherein
the pair of yoke legs has a portion extending with the recess portion in a length direction orthogonal to both a width direction and a thickness direction of the recess portion, and the formed magnetic field is formed by using a first conductor disposed on the recess portion along the length direction, a second conductor disposed along the length direction on a side opposite to the recess portion with respect to one of the pair of yoke legs in the width direction, and a third conductor disposed along the length direction on the side opposite to the recess portion with respect to the other of the pair of yoke legs in the width direction.

21. The magnetic field applying device according to claim 20, wherein
a direction of a current made to flow through the first conductor and a direction of the current made to flow through the second and third conductors are directions opposite to each other.

22. The magnetic field applying device according to claim 20, wherein
the first conductor is made of a pair of conductors separated in the width direction, and one of the conductors in the pair of conductors disposed on a side closer to one of the pair of yoke legs in the width direction is connected to the second conductor, and the other conductor in the pair of conductors disposed on the side closer to the other of the pair of yoke legs in the width direction is connected to the third conductor.

23. The magnetic field applying device according to claim 18, wherein
the magnetic body yoke further includes a plurality of additional yoke legs located at intervals from each other in a width direction between the pair of yoke legs and a recess portion formed between the pair of yoke legs and the plurality of additional yoke legs and between the plurality of additional yoke legs; and
a first magnetic field toward an upper surface of one yoke leg in the pair of yoke legs adjacent to one yoke leg in the plurality of additional yoke legs and/or toward the upper surface of any of the other yoke legs of the plurality of additional yoke legs adjacent to the one yoke leg from the upper surface of the one yoke leg passing through the work placed on the work placing portion in the width direction and a second magnetic field from the upper surface of one yoke leg in the pair of yoke legs adjacent to the one yoke leg in the plurality of additional yoke legs and/or from the upper surface of any of the other yoke legs in the plurality of additional yoke legs adjacent to the one yoke leg toward the upper surface of the one yoke leg passing through the work placed on the work placing portion in the width direction are formed alternately in the width direction between the pair of yoke legs and the plurality of additional yoke legs adjacent to each other.

24. The magnetic field applying device according to claim 23, wherein
the pair of yoke legs and the plurality of additional yoke legs has a portion extending with the recess portion in the length direction orthogonal to both the width direction and the thickness direction of the recess portion; and
the first magnetic field and the second magnetic field are formed by using a plurality of conductors disposed so as to sandwich each of the plurality of additional yoke legs in the width direction and disposed on the recess portion along the length direction.

25. The magnetic field applying device according to claim 24, wherein
a direction of the current made to flow through the conductor disposed on the one side in the width direction and a direction of the current made to flow through the conductor disposed on the other side in the width direction are directions opposite to each other for each of the plurality of additional yoke legs.

26. The magnetic field applying device according to claim 25, wherein
the conductor disposed on the one side in the width direction and the conductor disposed on the other side in the width direction are connected to each other for each of the plurality of additional yoke legs.
